(19) United States
(12) Patent Application Publication
(10) Pub. No.: US 2025/0370806 A1
(43) Pub. Date: Dec. 4, 2025

(54) Managing Resources for Parsing Stream Data

(71) Applicant: Oracle International Corporation, Redwood Shores, CA (US)

(72) Inventors: Aleksei Efimov, Dublin (IE); Daniel Jean-Michel Fuchs, Dublin (IE); Daniel Jelinski, Gdansk (PL); Jaikiran Pai, Dharwad (IN)

(73) Assignee: Oracle International Corporation, Redwood Shores, CA (US)

(21) Appl. No.: 19/084,262

(22) Filed: Mar. 19, 2025

Related U.S. Application Data
(60) Provisional application No. 63/654,509, filed on May 31, 2024.

(51) Int. Cl. G06F 9/50

(52) U.S. Cl. CPC G06F 9/5027

(57) ABSTRACT

Techniques for parsing stream data are disclosed. A system receives a first frame of a first set of frames. The first set of frames embeds a second set of frames. The system generates a first runtime object to represent at least part of the first frame that is stored in a first memory section. Based on determining that a first portion of the first frame does not need to be retained in memory, the system evaluates a size of a portion of the first frame relative to a threshold. Based on the evaluation, the system either (a) generates a second runtime object to represent a second portion of the first frame that is copied from the first memory section to a second memory section or (b) generates a third runtime object to represent the second portion of the first frame residing in the first memory section.

### BENEFIT CLAIMS; RELATED APPLICATIONS; INCORPORATION BY REFERENCE

This application claims the benefit of U.S. Provisional Patent Application 63/654,509, filed on May 31, 2024, that is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to data streaming. In particular, the present disclosure relates to parsing stream data.

### BACKGROUND

A data stream is a sequence of related, digitally encoded signals that are transmitted through a communication network. A communication network is two or more devices that are communicatively coupled by at least one network link. Devices in a communication network may include one or more software devices (e.g., virtual machines, cloud-based applications, software-defined networking controllers, etc.), hardware devices (e.g., routers, switches, hubs, etc.), and/or devices that combine both software and hardware (e.g., smartphones, servers, IoT devices, etc.). Network links in a communication network may include one or more wireless network links and/or wired network links.

Typically, a data stream is associated with at least one communication protocol. A communication protocol is a set of rules that govern how information is transmitted through a communication network. Among other aspects of a data stream, a communication protocol may dictate how units of data within the data stream are formatted and organized. Example units of stream data that may be found within a data stream include network packets, protocol frames, segments, bytes, bits, and other units of stream data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture that techniques described herein may be practiced according to an embodiment;

FIG. 2 is a block diagram illustrating one embodiment of a computer system suitable for implementing methods and features described herein;

FIG. 3 illustrates an example virtual machine memory layout in block diagram form according to an embodiment;

FIG. 4 illustrates an example frame in block diagram form according to an embodiment;

FIG. 5 illustrates a system for practicing techniques described herein according to an embodiment;

FIG. 6 illustrates example operations for parsing stream data according to an embodiment;

FIG. 7 illustrates example operations for managing resources according to an embodiment;

FIG. 8 illustrates an example network packet in block diagram form according to an example embodiment;

FIG. 9A illustrates example operations for replacing a protocol frame according to an example embodiment;

FIG. 9B illustrates an example frame slice in block diagram form according to an example embodiment;

FIG. 9C illustrates an example frame partition in block diagram form according to an example embodiment; and

FIG. 10 is a block diagram that illustrates a computer system according to an embodiment.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. STREAM DATA PARSING SYSTEM
4. PARSING STREAM DATA
5. MANAGING RESOURCES
6. EXAMPLE EMBODIMENT
   6.1 EXAMPLE PACKET ARCHITECTURE
   6.2 EXAMPLE FRAME REPLACEMENT
   6.3 EXAMPLE FRAME SLICE
   6.4 EXAMPLE FRAME PARTITION
7. HARDWARE OVERVIEW
8. MISCELLANEOUS; EXTENSIONS

### 1. GENERAL OVERVIEW

One or more embodiments use various techniques to handle extraneous stream data. The term “extraneous” is used herein to refer generally to information that is redundant, unwanted, unneeded, outdated, or otherwise surplus to the intended purpose, context, or operation of the system. Specifically, one or more embodiments create a new unit of stream data to replace a partially extraneous unit of stream data by (a) creating the new unit of stream data as a shared subsequence of the partially extraneous unit of stream data or (b) creating the new unit of stream data by copying the relevant (i.e., non-extraneous) part of the partially extraneous unit of stream data to another location in memory. One data item is referred to herein as a “shared subsequence” of another data item if both data items are, at least partially, representations of the same section of memory. Creating a new data item that includes part of another data item is referred to herein as “slicing” the other data item, if the new data item is a shared subsequence of the other data item. Creating a new data item that includes part of another data item is referred to herein as “partitioning” the other data item, if the new data item is created by copying that part of the other data item to another location in memory. Creating the new unit of stream data by slicing the partially extraneous unit of stream data may be relatively inexpensive computationally, because it avoids the computational cost of copying the relevant information delivered by the partially extraneous unit of stream data to another location. However, creating the new unit of stream data by slicing the partially extraneous unit of stream data may delay the system from reclaiming the memory space occupied by the extraneous information until after the new unit of stream data has been fully processed by the system. In comparison, creating the new unit of stream data by partitioning the incoming unit of stream data typically allows the system to reclaim the memory space that is reserved by the extraneous information shortly after the new unit of stream data is created.

One or more embodiments create a new unit of stream data to replace an original unit of stream data that is partially extraneous by either (a) slicing the original unit of stream data to prioritize computational efficiency or (b) partitioning the original unit of stream data to prioritize storage efficiency. To select the appropriate procedure for creating the new unit of stream data, the system may weigh (a) the computational savings associated with slicing the original unit of stream data against (b) the additional memory space that can be promptly reclaimed after partitioning the original unit of stream data. To inform this analysis, the system may evaluate one or more of (a) the amount of extraneous information delivered by the incoming protocol frame, (b) the amount of relevant information delivered by the incoming frame, (c) the amount of memory space occupied by a data structures storing the incoming frame, (d) memory resources presently available to the system, (e) processing resources presently available in the system, (f) trends in resource consumption, (g) indications of potentially malicious activity or the lack thereof, and/or (h) other information. One or more embodiments may repeat this analysis for some or all units of stream data that are delivered to the system. By selectively determining an appropriate approach for replacing individual units of stream data that are partially extraneous, the system parses stream data more efficiently and guards against any malicious attack that might seek to degrade the system's ability to quickly process stream data or overwhelm the system's memory resources.

One or more embodiments generate a new protocol frame to replace an original protocol frame that delivers partially extraneous information by either (a) slicing the original protocol frame to minimize the computational cost of creating the new protocol frame or (b) partitioning the original protocol frame to reduce the memory space that is reserved by the new protocol frame while the new protocol frame is being processed. To select an approach for creating the new protocol frame, the system may evaluate the amount of extraneous data delivered by the original protocol frame relative to a threshold. In a first example, the threshold is a threshold amount of data. If the amount of extraneous data delivered by the original protocol frame meets or exceeds the threshold amount of data, the system determines that the ability to promptly reclaim the memory space occupied by the extraneous data is worth the additional computational cost that is associated with partitioning the original protocol frame in this example. Therefore, if the amount of extraneous data delivered by the original protocol frame meets or exceeds the threshold amount of data, the system of this first example creates the new protocol frame by partitioning the original protocol frame. In a second example, the system generates a ratio that characterizes the amount of extraneous information delivered by the original protocol frame, and the system compares the ratio to a threshold ratio to determine how to create the new protocol frame. In a third example, the system determines how to create the new protocol frame based on a combination of (a) the threshold amount of data described above in the first example and (b) the threshold ratio described above in the second example. The system may dynamically adjust one or more thresholds that is/are used for determining how to create new protocol frames to account for observed changes in the system's operating conditions. For example, the system may adjust a threshold to favor partitioning frames in response to observing a decrease in the amount of memory that is available for storing frames.

One or more embodiments may generate a new protocol frame to replace an original protocol frame that is stored, at least in part, to an underlying data structure that occupies excess memory space. The excess memory may be occupied by extraneous data delivered by the original protocol frame, or the excess memory space may be occupied by other data (extraneous or relevant). To determine whether or not the original protocol frame should be replaced, the system may evaluate (a) the amount of relevant data delivered by the original protocol frame, (b) the amount of excess memory space, (c) the total amount of memory space occupied by the underlying data structure, and/or (d) other factors. The system may decide to replace the original protocol frame with a new protocol frame even if the original protocol frame does not deliver any extraneous data.

One or more embodiments described in this Specification and/or recited in the claims may not be included in this General Overview section.

### 2. ARCHITECTURAL OVERVIEW

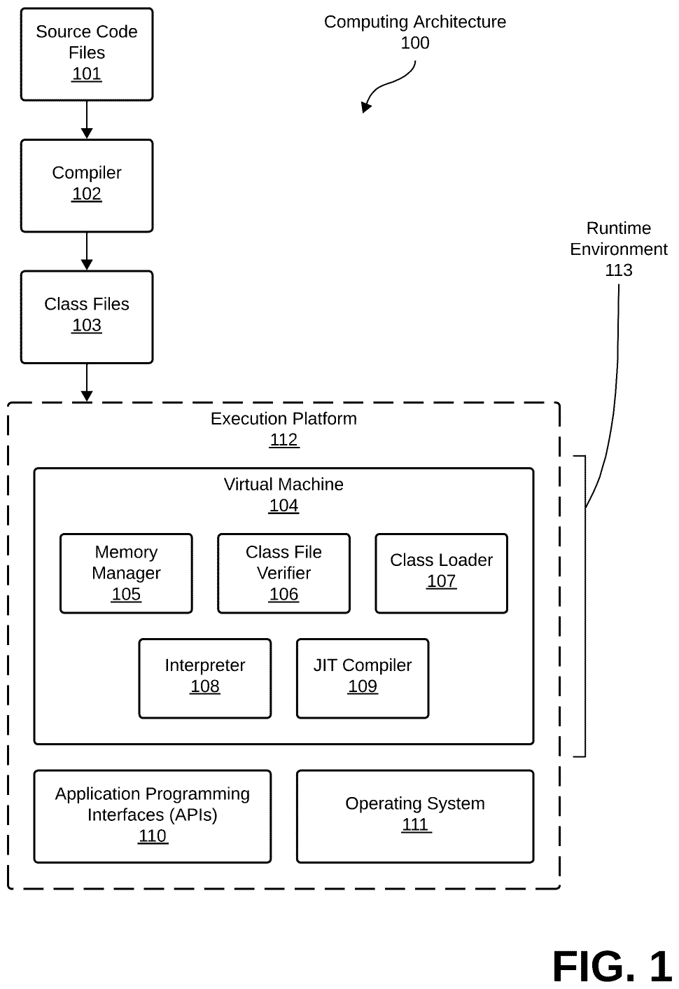

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that contain code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent runtime performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the runtime performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may contain one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

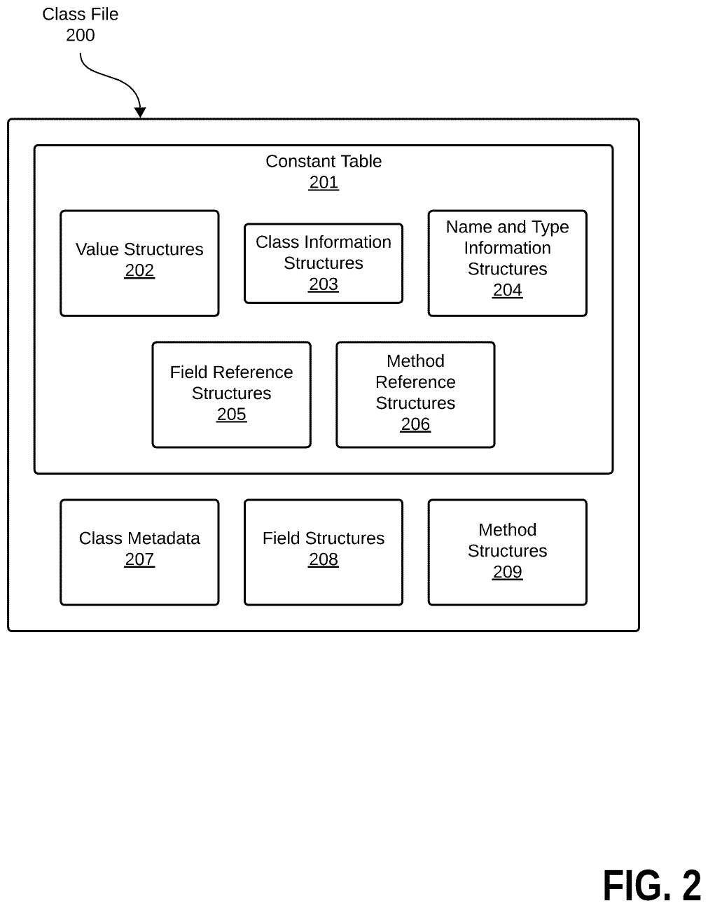

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g. “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m (int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:
class A
{int
   add12and13 ( ) {
      return B.addTwo (12, 13);
   }
}

In the above example, the Java method add12and13 is defined in class A, takes no parameters, and returns an integer. The body of method add12 and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I) I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the runtime representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

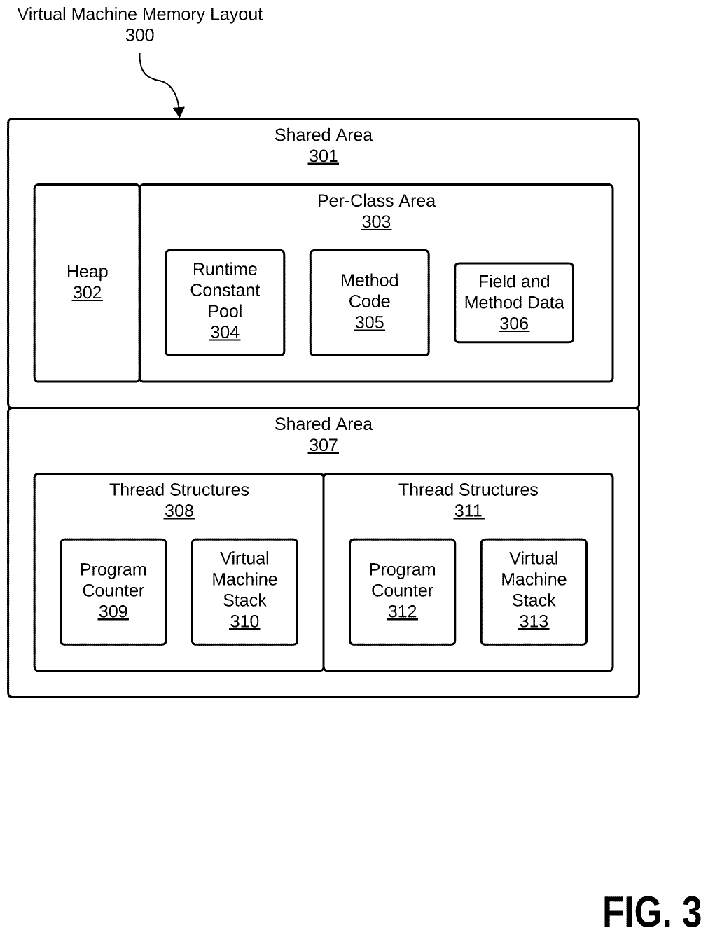

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the runtime data area from which memory for class instances and arrays is allocated. In an embodiment, the per-class area 303 represents the memory area where the data pertaining to the individual classes are stored. In an embodiment, the per-class area 303 includes, for a loaded class, a runtime constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

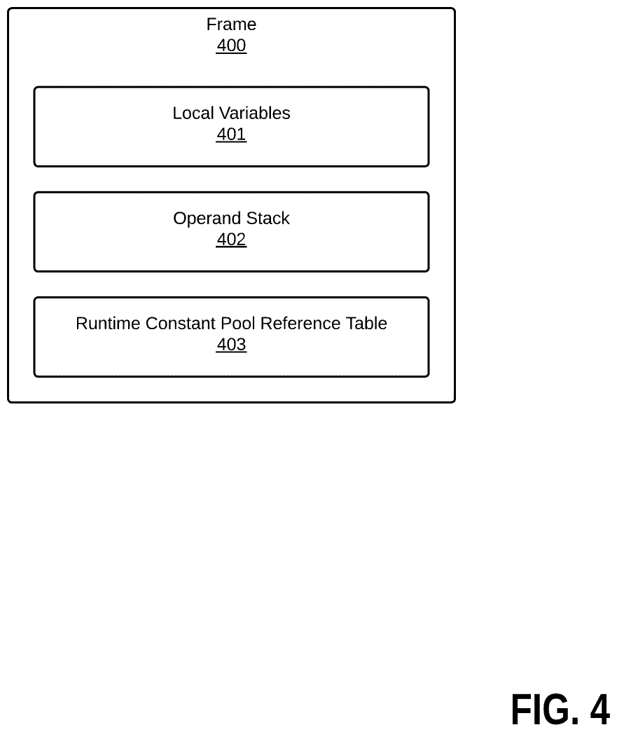

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and runtime constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the runtime constant pool reference table 403 contains a reference to the runtime constant pool 304 of the current class. The runtime constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the runtime location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the runtime constant pool 304, method code 305, and field and method data 306 for the class within the per-class area 303 of the virtual machine memory layout 300. Linking is the process of taking the in-memory representation of the class and combining it with the runtime state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the runtime constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the runtime constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the runtime constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. STREAM DATA PARSING SYSTEM

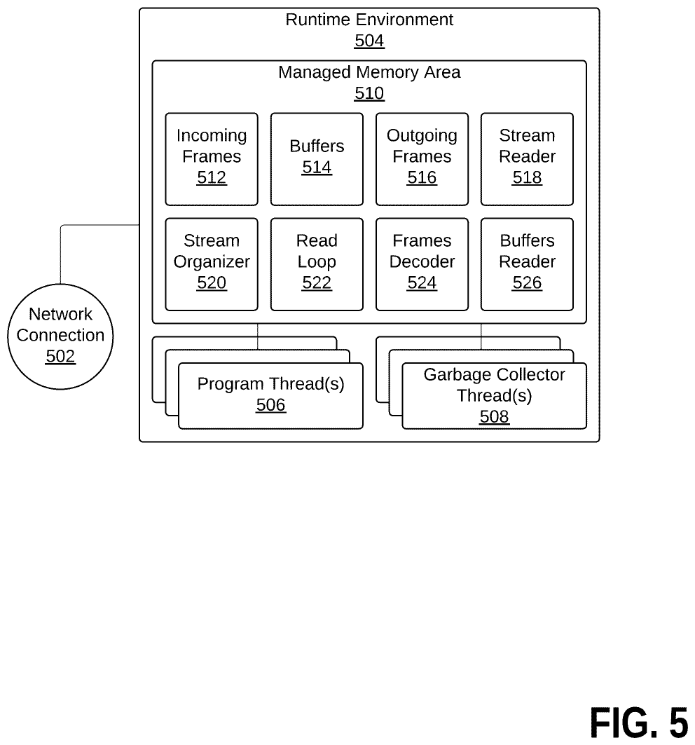

FIG. 5 illustrates a system 500 for practicing techniques described herein in accordance with one or more embodiments. As illustrated in FIG. 5, system 500 includes network connection 502 and runtime environment 504. In one or more embodiments, the system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

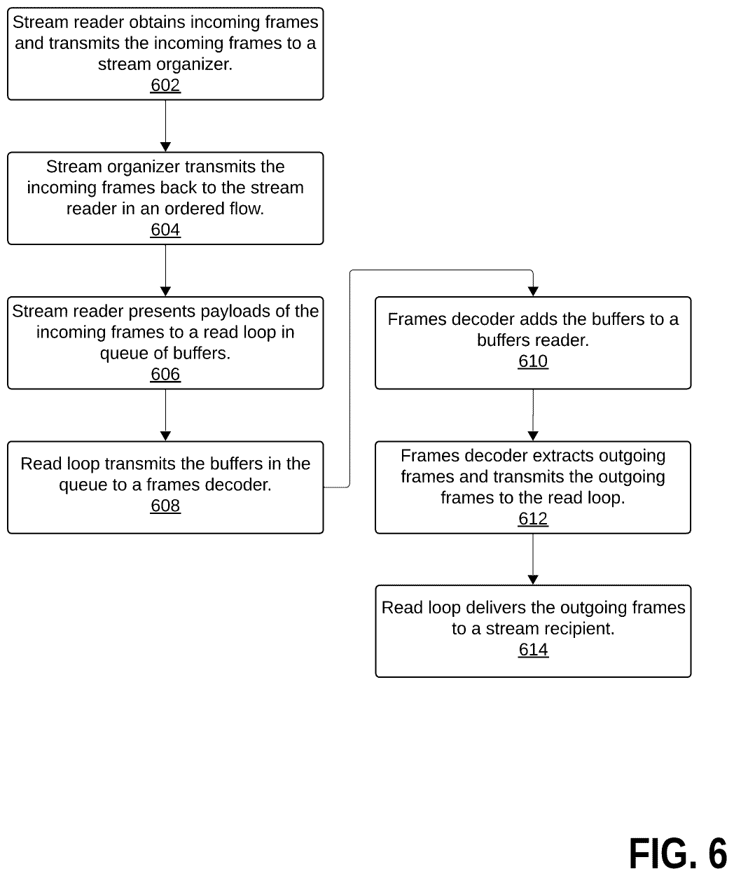

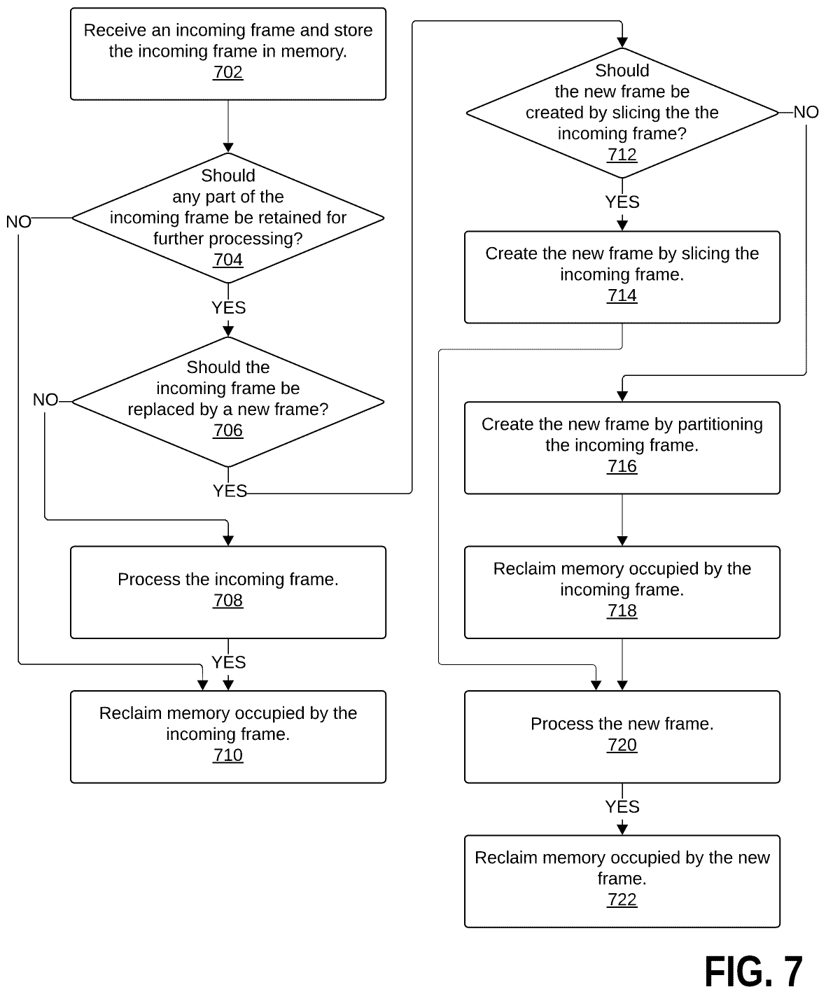

In one or more embodiments, system 500 refers to hardware and/or software configured to perform operations described herein for parsing stream data of one or more data streams. For brevity, a data stream may be referred to herein simply as a “stream.” Example operations for parsing stream data are described below with reference to FIG. 6 and FIG. 7. Additional embodiments and/or examples relating to parsing stream data are described within R01338NP, R01338N3, and R01338N4. The disclosures set forth by R01338NP, R01338N3, and R01338N4 are incorporated by reference in entirety as if set forth herein.

In an embodiment, network connection 502 is one or more network links of a communication network that is coupled to system 500. Network connection 502 delivers information to system 500, and/or network connection 502 transmits information from system 500. Network connection 502 includes physical link(s), and/or network connection 502 includes wireless link(s). The communication network that includes network connection 502 may be conceptualized in terms of layers of abstraction that model the flow of information within the communication network. As an example, consider the Open Systems Interconnection (OSI) model. The OSI model defines seven network layers. From lowest to highest, the seven network layers of the OSI model are (1) the physical layer, (2) the data link layer, (3) the network layer, (4) the transport layer, (5) the session layer, (6) the presentation layer, and (7) the application layer. For brevity, a layer of abstraction may be referred to herein simply as a “layer.”

In an embodiment, network connection 502 communicatively couples system 500 to at least one source of stream data. A source of stream data is local to a component of system 500, and/or a source of stream data is remote from a component of system 500. Furthermore, a source of stream data is located at the same physical site as a component of system 500, and/or a source of stream data is located a different physical site than a component of system 500. A source of stream data may be a component of system 500.

In an embodiment, network connection 502 is configured to transmit stream data in accordance with a single communication protocol, or network connection 502 is configured to transmit stream data system 500 in accordance with multiple communication protocols. For brevity, a communication protocol may be referred to herein simply as a “protocol.” Some protocols permit multiple streams to be established through a single network connection. Accordingly, depending on the protocol(s) associated with network connection 502, a single stream can be established through network connection 502, or multiple streams can be established through network connection 502.

In an embodiment, a protocol applicable to network connection 502 is associated with a single layer of a communication network that includes network connection 502, or the protocol is associated with multiple layers of the communication network. As used herein, the term “lower-layer protocol” refers to a protocol that is associated with lower-layer(s) of a communication network, and the term “higher-layer protocol” refers to a protocol that is associated with higher layer(s) of a communication network. In the context of the OSI model, for example, a lower-layer protocol is any communication protocol associated with at least one protocol that is not an application-layer protocol, and a higher-layer protocol is any protocol associated with at least one network layer that is not a physical-layer protocol. Network connection 502 may transmit stream data in accordance with physical-layer protocols, data-link-layer protocols, network-layer protocols, transport-layer protocols, session-layer protocols, presentation-layer protocols, application-layer protocols, and/or other protocols.

In an embodiment, network connection 502 is configured to transmit protocol frames to system 500, and/or network connection 502 is configured to transmit protocol frames from system 500. A frame pushed onto a virtual machine stack (e.g., virtual machine stack 310 or virtual machine stack 313) is distinct from a protocol frame. For brevity, a protocol frame may be referred to herein simply as a “frame.” Depending on the protocol(s) applicable to network connection 502, the frames transmitted through network connection 502 may be delivered to system 500 packaged within other units of stream data. In an example, network connection 502 delivers packets that are formatted according to one protocol, and these packets embed other packets that are formatted according to another protocol that is built on top of the one protocol. The other packets in this example embed frames that are formatted according to the other protocol. A protocol may define multiple types of frames that serve various purposes, and the protocol may specify different formats for the different frame types. Example frame types that may be defined by a protocol include authentication frames, data frames, connection control frames, acknowledgement frames, flow control frames, error control frames, management frames, handshake frames, synchronization frames, and others. A format for a frame that is specified by a protocol may dictate that the frame include a header, a payload, padding, a footer, and/or other components. If a frame includes a header, the header typically encodes frame metadata. For example, a header of a frame may specify a frame type, a stream ID, a frame offset, a frame length, and/or other information. In this example, the stream ID of the frame identifies a stream that the frame belongs to. The frame offset of the frame in this example indicates the position of the frame's payload within a stream, and the frame length of the frame indicates the size of the payload. One type of frame may carry a payload, and another type of frame may not carry a payload. A payload of a frame may carry other units of stream data. For example, the payloads of frames formatted according to one protocol (e.g., a lower-layer protocol) may encode other frames that are formatted according to another protocol (e.g., a higher-layer protocol).

In an embodiment, runtime environment 504 is a computing environment for executing one or more program instances. Runtime environment 504 provides resources for running program instance(s) and/or other processes that support the proper functioning of the program instance(s) and the wider runtime environment 504. Runtime environment 504 includes processing resources, and runtime environment 504 includes memory resources. As illustrated in FIG. 5, runtime environment 504 may include program thread(s) 506, garbage collector thread(s) 508, and managed memory area 510. An example runtime environment 504 typically includes various other resources that are not illustrated in FIG. 5.

In an embodiment, runtime environment 504 is implemented in the context of one or more class-based, object-oriented programming languages. Examples of class-based, object-oriented programming languages include Java, C++, C#, Python, Ruby, and others. The implementation of runtime environment 504 in the context of class-based, object-oriented program language(s) is described herein for illustrative purposes and is not intended to define any limits to the disclosure. The techniques described herein are equally applicable to other computing environments and other programming languages.

In an embodiment, program thread(s) 506 and garbage collector thread(s) 508 are threads of execution. A thread of execution is an independent execution environment for machine-level instructions. The runtime environment 504 of this embodiment includes multiple threads, or the runtime environment 504 includes a single thread. A thread may be a program thread 506 at one moment, and the thread may be a garbage collector thread 508 at another moment. A typical implementation of the Java Runtime Environment is one example of a multi-thread computing environment, and a typical implementation of the Java Card Runtime Environment is one example of a single-thread computing environment. A multi-thread computing environment is an example of a computing environment that is capable of performing concurrent operations. The implementation of runtime environment 504 as a threaded computing environment is described herein for illustrative purposes and is not intended to define any limits to this disclosure. The techniques described herein are equally applicable to other computing architectures.

In an embodiment, a program thread 506 is a thread of execution that is currently performing operations at the behest of a program instance. A program thread 506 is often manipulating information residing in managed memory area 510 while executing machine-level instructions associated with a program instance. For instance, while completing the requests of a program, a program thread 506 may be creating new data structures within managed memory area 510, reading from data structures residing in managed memory area 510, writing to data structures residing in managed memory area 510, and/or performing various other operations within managed memory area 510. An example program instance that is executed, at least in part, by a program thread 506 is configured to parse stream data delivered to system 500 through network connection 502.

In an embodiment, a garbage collector thread 508 is a thread of execution that is currently performing operations at the behest of a garbage collection process. As used herein, the term “garbage collection” refers to memory management. In the example context of runtime environment 504, a garbage collection process may be configured to reclaim memory allocated to data structures residing within managed memory area 510 that are no longer needed by a currently executing program instance. For instance, a garbage collector thread 508 may reclaim memory space allocated to data structures that were previously being used by a program instance to buffer stream data delivered to system 500 through network connection 502.

In an embodiment, managed memory area 510 is a data repository that serves, at least in part, as runtime memory for one or more program instances. In addition to including information that can be manipulated by a program instance, managed memory area 510 may include information that is not exposed at a program-level. A data repository is any type of storage unit and/or device (e.g., a file system, database, collection of tables, or any other storage mechanism) for storing data. Furthermore, a data repository may include multiple different storage units and/or devices. The multiple different storage units and/or devices of a data repository may or may not be of the same type or located at the same physical site. A data repository may be implemented in volatile memory, and/or the data repository may be implemented in persistent memory.

In an embodiment, information is represented within managed memory area 510 by runtime objects. A runtime object is a data structure that exists in memory while a program instance is currently executing. Generally, a runtime object is an abstraction of binary data that resides somewhere in low-level memory. For example, a runtime object may be an abstraction of binary data stored to main memory (e.g., random access memory). In the example illustrated by FIG. 3, a managed memory area 510 may be implemented within heap 302. In this example, the managed memory area 510 will typically include various other runtime objects that are not represented in FIG. 5. Managed memory area 510 is “managed” in the sense that managed memory area 510 may be subjected to a garbage collection process during runtime. For instance, an example garbage collection process is configured to reclaim memory space allocated to runtime objects residing in managed memory area 510. The example garbage collection process deems memory space allocated to a runtime object eligible for reclamation if that runtime object has become less than strongly reachable. A runtime object is strongly reachable if there is a chain of strong reference(s) that can be traversed by a program thread 506 to access that runtime object. In contrast, if there is no chain of strong reference(s) that can be traversed by a program thread 506 to access a runtime object, that runtime object is not strongly reachable. A runtime object being less than strongly reachable to a program thread 506 does not necessarily imply that the runtime object is unreachable to a program thread 506. For example, a runtime object that is not strongly reachable may remain reachable through a non-strong reference. An example strong reference is a default reference that is typically used to refer to a runtime object. An example non-strong reference is a special type of reference that is created by a reference object (e.g., a soft reference object, a weak reference object, a final reference object, a phantom reference object, a native weak reference object, etc.). Furthermore, the term “unreachable” is not necessarily synonymous with the term “inaccessible.” For example, a runtime object that is unreachable to a program thread 506 may remain accessible to a garbage collector thread 508. As used herein, the term “disposable” identifies information that is eligible for garbage collection, and the term “live” identifies information that is ineligible for garbage collection. A runtime object may provide access to a method that is defined by a reference type that is related to the runtime object. A runtime object may be described herein as performing an operation if a method (e.g., an instance method, a static method, etc.) defined by a related reference type is executed. As an example, consider an instance of a class that defines a method for writing to an object field, and assume that the method is called on the class instance. In this example, the class instance is said to “write to an object field” when a thread executes machine-level instructions corresponding to the operations defined in the method body of the method. A method need not be invoked for that method to be executed. If a method is invoked, the method is invoked explicitly, or the method is invoked implicitly.

In an embodiment, managed memory area 510 includes mechanisms for parsing stream data, and/or managed memory area 510 includes other information. As illustrated in FIG. 5, managed memory area 510 may include incoming frames 512, buffers 514, outgoing frames 516, stream reader 518, stream organizer 520, read loop 522, frames decoder 524, and/or buffers reader 526. Information describing incoming frames 512, buffers 514, outgoing frames 516, stream reader 518, stream organizer 520, read loop 522, frames decoder 524, and/or buffers reader 526 may be implemented across any of the components within system 500 (components illustrated in FIG. 5 and otherwise) (e.g., a per-class area, a virtual machine stack, local variables, an operand stack, etc.). However, this information is depicted by FIG. 5 solely within the bounds of managed memory area 510 for purposes of clarity and explanation.

In an embodiment, an incoming frame 512 is a protocol frame that represents stream data received by system 500 through network connection 502. An incoming frame 512 may be delivered to the system 500 as binary stream data that is formatted according to a protocol, and the incoming frame 512 may subsequently be manifested in managed memory area 510 as a higher-level abstraction of that binary data that is formatted according to a reference type. An incoming frame 512 is associated with a single protocol, or the incoming frame 512 is associated with multiple protocols. An incoming frame 512 may be associated with a lower-layer protocol, a higher-layer protocol, and/or another variety of communication protocol.

In an embodiment, an incoming frame 512 is associated with a lower-layer protocol. For instance, an incoming frame 512 may be associated with a transport-layer protocol. Example transport-layer protocols that may be associated with an incoming frame 512 include the following: the Transmission Control Protocol (TCP), the User Datagram Protocol (UDP), the QUIC Protocol, the Stream Control Transmission Protocol (SCTP), the Datagram Congestion Control Protocol (DCCP), the Reliable User Datagram Protocol (RUDP), and others. Recall that any given protocol may define different frame types that serve distinct purposes. Frame types of the QUIC Protocol, for example, include a stream frame, a crypto frame, a connection control frame, an acknowledgement frame, and others. The QUIC Protocol is built on top of the UDP, and the QUIC Protocol uses UDP to deliver the features of the QUIC Protocol. As an example, assume that a QUIC stream is established through network connection 502. In this example, network connection 502 may deliver datagrams to system 500. Datagrams are packets formatted according to the UDP. The UDP datagrams of this example embed other packets formatted according to the QUIC Protocol (i.e., QUIC packets). If a datagram embeds a QUIC packet in this example, the datagram embeds a single QUIC packet, or the datagram embeds multiple QUIC packets. The QUIC packets of this example may embed incoming frames 512 formatted according to the QUIC Protocol (i.e., QUIC frames). A QUIC packet of this example embeds a portion of a QUIC frame, a single QUIC frame, and/or multiple QUIC frames. In this example, the QUIC frames may, in turn, embed other frames that accord to a higher-layer protocol (e.g., an application-layer protocol). To provide consistent examples, the QUIC Protocol is used as an example at multiple points in this Detailed Description. These examples are provided for the reader's convenience and should not be interpreted as limiting the scope of one or more embodiments.

In an embodiment, an incoming frame 512 overlaps with another incoming frame 512. An incoming frame 512 is said to “overlap” with another incoming frame 512 if the data carried by that incoming frame 512 overlaps with the data carried by the other incoming frame 512. For example, if the payload of one incoming frame 512 carries stream data that also appears, at least in part, in the payload of another incoming frame 512, the one incoming frame 512 is said to overlap with the other incoming frame 512. Overlapping incoming frames 512 can be identified based on frame metadata. For example, the system 500 may identify two overlapping incoming frames 512 based on a comparison between the two incoming frames' (a) stream IDs, (b) frame offsets, and/or (c) frame lengths (e.g., by comparing frame offsets and frame lengths). The frame metadata that is used by the system 500 to identify overlaps between incoming frames 512 may vary depending on the protocol associated with the incoming frames 512, the frame type of the incoming frames 512, and other factors. If two incoming frames 512 partially overlap with one another, the system 500 may deem one of those two incoming frames 512 partially extraneous. The term “extraneous” is used herein to refer generally to any information that is redundant, unwanted, unneeded, outdated, or otherwise surplus to the intended purpose, context, or operation of the system.

In an embodiment, an incoming frame 512 is a duplicate of another incoming frame 512. Incoming frames 512 are referred to as “duplicates” if those incoming frames share at least some identical attributes. For example, an incoming frame 512 is referred to as a “duplicate” of another incoming frame 512 if both incoming frames 512 deliver the same payload. A duplicate incoming frame 512 need not be a frame that carries a payload. Duplicate incoming frames 512 can be identified based on frame metadata. For example, two incoming frames 512 that carry the same payload will specify the same stream ID, frame offset, and frame length. If two incoming frames 512 are duplicates of one another, the system 500 may deem one of those two incoming frames 512 fully extraneous.

In an embodiment, an incoming frame 512 is manifested in managed memory area 510 as a runtime object that is related to an incoming frames reference type. For instance, an incoming frame 512 may be manifested as an instance of an incoming frames class, or the incoming frame 512 may be manifested as an instance of a subclass that directly or indirectly extends the incoming frames class. Additionally, or alternatively, an incoming frame 512 may be manifested as an instance of a class that directly or indirectly implements an incoming frames interface. As an example, assume that an incoming frame 512 received through network connection 502 is a QUIC frame. The QUIC frame of this example is, more specifically, a stream frame that delivers a payload of stream data. In this example, the stream frame is manifested in managed memory area 510 as an instance of a stream frame class that extends a QUIC frames class (i.e., an incoming frames reference type). An incoming frame's 512 manifestation as a runtime object generally includes object field(s) that hold frame metadata. The frame metadata carried by object fields of an incoming frame may correspond to binary data that is carried by the header of that incoming frame 512. For example, the object fields of an incoming frame 512 may hold a frame type, a stream ID, a frame offset, a frame length, and/or other information. Additionally, or alternatively, frame metadata held by object fields of an incoming frame 512 may be derived from other sources of information, such as other incoming frames 512 that are constituents of the same stream, a packet that encapsulates the incoming frame 512, and so on. An incoming frames reference type may vary depending on the protocol(s) associated with the incoming frame 512, the frame type of the incoming frame 512 (e.g., an authentication frame, a frame carrying a payload of stream data, a connection control frame, etc.), and/or other factors. Accordingly, the object fields, instance methods, and other aspects of a runtime object manifesting an incoming frame 512 may also vary.

In an embodiment, a buffer 514 is an abstraction that serves as a mechanism for storing information in memory. For instance, a buffer 514 may act as a mechanism for storing stream data in memory, and/or the buffer 514 may serve as a mechanism for holding other information in memory. A buffer 514 may be configured to act as a storage mechanism for a specific primitive data type. Example buffers 514 include byte buffers 514, char buffers 514, double buffers 514, float buffers 514, int buffers 514, long buffers 514, short buffers 514, and others. In general, a buffer 514 is configured to provide other components of system 500 access to a dataset that is presented by the buffer 514.

In an embodiment, a buffer 514 is an abstraction that is backed by an underlying data structure, and the underlying data structure may, in turn, be backed by even lower-level data structures. An array is an example of an underlying data structure that may back a buffer 514. When a dataset is “stored” to a buffer 514, the binary data encoding that dataset is, in actuality, being stored to the underlying data structure that is backing the buffer 514. For example, when binary data is stored to a byte buffer 514, that binary data may be encoded into an underlying byte array that backs the buffer 514. An underlying data structure that backs a buffer 514 may reside in managed memory area 510, or the underlying data structure that backs a buffer 514 may reside outside of managed memory area 510 (e.g., in native memory).

In an embodiment, a buffer 514 provides methods for accessing data stored to the buffer 514. As an example, consider a byte buffer 514 that is backed by a byte array. In this example, the byte buffer 514 may provide methods for retrieving information from the byte array, writing to the byte array, clearing the byte array, modifying the byte order of the byte array, and performing other operations.

In an embodiment, a buffer 514 is backed by an underlying data structure, and the buffer 514 indexes elements that are both (a) included within the underlying data structure and (b) represented by the buffer 514. An example buffer 514 indexes elements starting from zero. As used herein, the term “element” refers herein to some unit of data. Example elements that may be indexed by a buffer 514 include bits, bytes, characters, integers, floats, shorts, longs, custom elements, and others. A data structure that backs a buffer 514 may include elements that are not represented by the buffer 514, and the data structure may index elements differently than the buffer 514. The location of an element with respect to the indexing of a buffer 514 that represents the element is referred to herein as the “relative position” of the element, and the location of an element with respect to the indexing of an underlying data structure that backs the buffer 514 and stores the element is referred to herein as the “local position” of the element. A difference between the relative position of an element and the local position of the element is referred to herein as an “array offset.” The relative position of an element represented by a buffer 514 is equal to the local position of that element plus the array offset.

In an embodiment, a buffer 514 maintains variable(s) that characterize (a) the buffers 514 and/or (b) elements represented by the buffers 514. Example variables that may be maintained by a buffers 514 include (a) an array offset, (b) a read position, (c) a limit, (d) a capacity, and (e) others. An array offset of a buffer 514 is specified with respect to the indexing of an array that backs the buffer 514. In other words, an array offset indicates the distance between the starting point of an array backing a buffer 514 and the first element represented by that buffer 514. If the array offset is zero, the indexing of the array will coincide with the indexing of the example buffer 514; however, if the array offset is a non-zero value, the indexing of the example buffer 514 will be staggered from the indexing of the array. The read position of a buffer 514 is the relative position of the element that should be read next. The limit of a buffer 514 is the relative position of the first element that should not be accessible through the buffer 514. For example, if the limit of a buffer 514 is five, the last element that should be accessible through the buffer 514 has a relative position of four. The capacity of the buffer 514 is the number of elements that are represented by the buffer 514. An element represented by a buffer 514 may be read, or the element may be unread. An element is referred to herein as a “read element” if the relative position of that element is less than the read position of a buffer 514 that represents that element. A buffer 514 is referred to herein as “fully read” if the buffer 514 does not represent any unread elements. For example, a buffer 514 is fully read if the read position of the buffer 514 matches the limit of the buffer 514. A buffer 514 is referred to herein as “partially read” if (a) at least one element represented by the buffer 514 has been read and (b) at least one element represented by the buffer 514 has not been read. As an example, assume that a buffer 514 indexes elements represented by the buffer 514 starting from zero. In this example, the buffer 514 is partially read if the read position of the buffer 514 is both (a) greater than zero and (b) less than the limit of the buffer 514. A buffer 514 is referred to herein as “fully unread” if no elements represented by the buffer 514 have been read (e.g., the read position of the buffer 514 is zero).

In an embodiment, a buffer 514 offers getter methods that are configured to return variables of the buffer 514. For instance, among other methods, an example buffer 514 offers a “position” method and a “limit” method. The position method of the example buffer 514 returns the read position of the example buffer 514, and the limit method of the example buffer 514 returns the limit of the example buffer 514. It should be noted that the example buffer 514 offers separate setter methods having these same names (i.e., “position” and “limit”) that can be used to alter the read position and limit of the example buffer 514. In addition, a buffer 514 may provide method(s) that determine other attributes of the buffer 514 based on variables maintained by the buffer 514. For instance, the example buffer 514 offers a “has remaining” method and a “remaining” method. The has remaining method of the example buffer 514 is a Boolean method that returns true if the example buffer 514 represents at least one unread element. The remaining method of the example buffer 514 is an integer method that returns the number of unread elements represented by the example buffer 514.

In an embodiment, a buffer 514 provides method(s) for reading element(s) represented by the buffer 514. As used herein, the phrase “reading through a buffer” 514 refers to retrieving element(s) represented by the buffer 514 and recording those element(s) as being read. An example buffer 514 (e.g., a byte buffer) offers a relative “get” method that can be used to read from the buffer 514. If the relative get method is invoked, the relative get method is configured to (a) return the element (e.g., a byte) that resides at the read position of the example buffer 514 and (b) increment the read position of the example buffer 514 by one element (e.g., one byte). The example buffer 514 may provide multiple relative get methods. For instance, the example buffer 514 may also provide a relative get method that can be used to read multiple elements.

In an embodiment, a buffer 514 offers method(s) for peeking elements represented by the buffer 514. As used herein, the phrase “peeking through a buffer” 514 refers to retrieving element(s) represented by the buffer 514 without recording those element(s) as being read. An example buffer 514 provides absolute “get” method(s) that can be used to peek through the example buffer 514. Executing an absolute get method of the example buffer 514 does not alter a read position of the example buffer 514.

In an embodiment, a buffer 514 offers setter methods for altering variables maintained by the buffer 514. For instance, among other methods, an example buffer 514 provides a “position” method for setting the read position of the example buffer 514 to a relative position that is specified as an input parameter, and the example buffer 514 provides a “limit” method for altering the limit of the example buffer 514 to a relative position specified as an input parameter.

In an embodiment, a buffer 514 provides method(s) for creating a new buffer 514. For example, a byte buffer 514 may provide methods for slicing the byte buffer object to create a new byte buffer 514, allocating a new byte buffer 514, duplicating the byte buffer 514, and performing other operations. An example slice method of a buffer 514 creates a new buffer 514 that is a shared subsequence of the buffer's 514. In other words, the example slice method creates a new buffer 514 that is backed by the same underlying data structure (e.g., a byte array object) as the original buffer 514. In contrast, an example allocate method of a buffer 514 can be used to create a new buffer 514 that is backed by a separate underlying data structure.

In an embodiment, a buffer 514 is a runtime object that is related to a buffer reference type. As an example, consider a byte buffer 514. In this example, the buffer reference type is a buffer class, and the byte buffer 514 is an instance of a byte buffer class that extends the buffer class. In this example, the byte buffer 514 may be backed by a byte array that is represented in managed memory are 510 by an array object. The buffer class also possesses other subclasses for other types of buffers 514 in this example.

In an embodiment, a buffer 514 stores the payload of an incoming frame 512. More specifically, a payload of an incoming frame 512 is stored to an underlying data structure that backs a buffer 514, and the buffer 514 serves as the payload's representation in managed memory area 510. An incoming frame's 512 payload is often the majority of the data that is delivered by the incoming frame 512; accordingly, the majority of the memory space that describes an incoming frame 512 may be allocated to the underlying data structure that store's the incoming frame's 512 payload.

In an embodiment, a buffer 514 serving as a representative of an incoming frame's 512 payload offers method(s) that can be used to manipulate the data delivered within the payload. For instance, if the payload of an incoming frame 512 is partially extraneous, that payload may be sliced or partitioned by calling a method on a representative buffer 514. Creating a new data item that includes part of another data item is referred to herein as “slicing” the other data item if the new data item is a shared subsequence of the other data item. Creating a new data item that includes part of another data item is referred to herein as “partitioning” the other data item if the new data item is created by copying that part of the other data item to another location in memory. As an example, assume that an incoming frame 512 delivers a payload of partially extraneous binary stream data to the system 500. In this example, the incoming frame's 512 payload is stored to a byte array that backs a byte buffer 514, and the byte buffer 514 represents the incoming frame's payload in managed memory area 510. The payload of this example can be sliced by calling a slice method on the byte buffer 514, and the payload can be partitioned by calling an allocate method on the byte buffer 514. Calling the slice method on the byte buffer 514 in this example may result in the creation of a new byte buffer 514 that is backed by the same byte array as the original byte buffer 514. In comparison, calling the allocate method on the byte buffer 514 in this example may result in the creation of a new byte buffer 514 that is backed by a newly allocated byte array. Different parts of a protocol frame may be stored in different sections of memory. As an example, consider an incoming frame 512 that delivers a payload. The payload of this example is represented by a buffer 514 that is backed by an underlying data structure storing the payload. In this example, the incoming frame 512 (i.e., a runtime object representing a protocol frame in managed memory 510) may be stored in a different section of memory than the buffer 514 and/or the payload. The phrase “slicing a protocol frame” may refer herein to slicing any part of that protocol frame. For example, calling a slice method on a buffer 514 that stores an incoming frame's 512 payload may be referred to as “slicing the incoming frame 512” even though the incoming frame 512 may be described in a section of memory that is separate from the section of memory that describes the payload. Similarly, partitioning any part of a protocol frame may be referred to as “partitioning that protocol frame.” For example, calling an allocate method on a buffer 514 that represent an incoming frame's 512 payload may be referred to herein as “partitioning the incoming frame 512.”

In an embodiment, an outgoing frame 516 includes stream data delivered by system 500 to a stream recipient. A stream recipient may reside within runtime environment 504, or a stream recipient may reside outside of runtime environment 504. A stream recipient is local to a component of system 500, and/or a stream recipient is remote from a component of system 500. A stream recipient is located at the same physical site as a component of system 500, and/or a stream recipient is located at a different physical site than a component of system 500. An outgoing frame 516 is associated with a single protocol, or an outgoing frame 516 is associated with multiple protocols. An outgoing frame 516 may be associated with lower-layer protocols, higher-layer protocols, and/or other protocols. In an example, an outgoing frame 516 is an incoming frame 512. In another example, an outgoing frame 516 is decoded from the payload of an incoming frame 512. If an outgoing frame 516 is delivered to system 500 embedded in other units of stream data, that outgoing frame 516 may be arbitrarily divided between multiple units of stream in a manner that will vary depending on the protocols involved in delivering that outgoing frame 516 to system 500.

In an embodiment, an outgoing frame 516 is associated with a higher-layer protocol (i.e., the outgoing frame 516 is a higher-layer frame). For instance, an outgoing frame 516 may be associated with an application-layer protocol. Example application-layer protocols that may be associated with an outgoing frame 516 include Hypertext Transfer Protocol (HTTP) (e.g., HTTP/1.0, HTTP/1.1, HTTP/2, HTTP/3, etc.), Hypertext Transfer Protocol Secure (HTTPS), File Transfer Protocol (FTP), Simple Mail Transfer Protocol (SMTP), Post Office Protocol version 3 (POP3), Internet Message Access Protocol (IMAP), Dynamic Host Configuration Protocol (DHCP), Domain Name System (DNS), Telnet, Secure Shell (SSH), Simple Network Management Protocol (SNMP), and others. In an example, outgoing frames 516 are HTTP/3 frames that are delivered to system 500 encoded into the payloads of QUIC stream frames (i.e., incoming frames 512). In this example, an HTTP/3 frame is embedded into a single QUIC stream frame, or the HTTP/3 frame is embedded into multiple QUIC stream frames. Upon delivery to system 500 in this example, the HTTP/3 frame is stored to a single buffer 514 (e.g., a byte buffer 514), or the HTTP/3 frame is stored to multiple buffers 514. To provide consistent examples, HTTP/3 is used as an example at multiple points in this Detailed Description. These examples are provided for the reader's convenience and should not be interpreted as limiting the scope of one or more embodiments.

In an embodiment, an outgoing frame 516 is manifested in managed memory area 510 as a runtime object that is related to an outgoing frame reference type. In an example, the outgoing frame reference type is an outgoing frame interface, and an outgoing frame 516 is manifested in managed memory area 510 as an instance of a class that directly or indirectly implements the outgoing frame interface. In another example, the outgoing frame reference type is an outgoing frame class, and an outgoing frame 516 is manifested in managed memory as an instance of a subclass that directly or indirectly extends the outgoing frame class. An outgoing frame's 516 manifestation as a runtime object may include object fields that hold frame metadata corresponding to binary data specified in a header of the outgoing frame 516 and/or another source of information. In general, the content of an outgoing frame 516 may vary depending on (a) a protocol associated with the outgoing frame 516, (b) a frame type of the outgoing frame 516, and/or (c) other factors.

In an embodiment, an outgoing frame 516 is related to an outgoing frame reference type, and the outgoing frame reference type offers method(s) that can be used to manipulate the outgoing frame 516. For example, the outgoing frame reference type may offer a static “decode” method that is configured to return an outgoing frame 516 that is decoded from a continuous sequence of elements presented by a buffers reader 526. The decode method of this example is configured to accept a buffers reader 526 and a predicate as input parameters. In this example, the predicate is a functional interface that is used by the decode method to determine if the frame type of an outgoing frame 516 presented by the buffers reader 526 is permissible. If the frame type of an outgoing frame 516 is permissible, the decode method of this example typically (a) returns the outgoing frame 516 modeled as a complete frame, (b) returns the outgoing frame 516 modeled as a partial frame, or (c) returns null if the continuous sequence of elements does not include sufficient information to decode the outgoing frame 516. If the frame type of an outgoing frame 516 is not permissible, the decode method of this example typically returns the outgoing frame 516 modeled as a malformed frame.

In an embodiment, an outgoing frame 516 is modeled as a complete frame. If an outgoing frame 516 is modeled as a complete frame, delivery of the outgoing frame 516 typically begins after the entirety of the outgoing frame 516 is decoded. Outgoing frames 516 that deliver fixed-length payloads are often modeled as complete frames. Examples of HTTP/3 frames that may be modeled as complete frames include (a) settings frames, (b) go away frames, (c) cancel push frames, (d) max push ID frames, and (e) others. In an example, an outgoing frame 516 is manifested in managed memory area 510 as a complete frame by an instance of a complete frame subclass that corresponds to the frame type of the outgoing frame 516. For instance, the complete frame subclass of this example may be (a) a settings frame subclass, (b) a go away frame subclass, (c) a cancel push frame subclass, (d) a max push ID frame subclass, or (e) another subclass. In this example, the complete frame subclass offers a static “decode frame” method that can be used to create a new complete frame of the frame type corresponding to the subclass. The decode frame method of this example accepts a buffers reader as an input parameter. If the decode frame method of this example is invoked, the decode frame method is configured to attempt to decode a new complete frame from a continuous sequence of elements presented by the buffers reader that was specified as an input parameter to the invocation of the decode frame method.

In an embodiment, an outgoing frame 516 is modeled as a partial frame. If an outgoing frame 516 is modeled as a partial frame, the system 500 may begin delivery of data included in the outgoing frame 516 before the outgoing frame 516 is fully decoded. Examples of HTTP/3 frames that may be modeled as partial frames include (a) headers frames, (b) data frames, (c) push promise frames, (d) HTTP/3 frames with unknown frame types, and (e) others. In an example, an outgoing frame 516 is manifested in managed memory area 510 as a partial frame by an instance of a partial frame subclass (i.e., a subclass of a partial frame class), and the partial frame subclass corresponds to the frame type of the partial frame. For instance, the partial frame subclass of this example may be (a) a headers frame subclass, (b) a data frame subclass, (c) a push promise frame subclass, (d) an unknown frame subclass, or (e) another partial frame subclass.

In an embodiment, an outgoing frame 516 is modeled as a partial frame, and the partial frame maintains variable(s) that track the state of the outgoing frame's 516 payload. As an example, assume that an outgoing frame 516 is encoded into bytes that are abstracted by byte buffer(s). In this example, the partial frame maintains a streaming length variable, a remaining variable, and/or other variables. The streaming length variable of this example measures the number of bytes that encode the outgoing frame's 516 payload, and the remaining variable of this example measures the number of bytes encoding the outgoing frame's 516 payload that have not yet been delivered to a stream recipient. In this example, the partial frame offers a “streaming length” method that is configured to return the value stored in the streaming length variable, and the partial frame offers a “remaining” method that is configured to return the value stored in the remaining variable. The partial frame of this example also offers a “next payload bytes” method that is configured to accepts a buffers reader 526 as an input parameter. In this example, the next payload bytes method of the partial frame is configured to return any bytes encoding payload data of the outgoing frame 516 that (a) have not already been delivered to a stream recipient and (b) are presently available for decoding. The next payload bytes of the partial frame of this example returns these bytes as a list of byte buffers that abstract these bytes. In addition, the next payload bytes method of this example is configured to update a read position of a buffers reader 526 to reflect the retrieval of any bytes that encode payload data of the outgoing frame 516.

In an embodiment, an outgoing frame 516 is modeled as an unknown frame. An unknown frame is a partial frame that models an outgoing frame 516 with an unknown frame type. In an example, the system determines if the frame type of an outgoing frame 516 is a known frame type by executing a static “for type” method that is offered by a frame type class while specifying the frame type of the outgoing frame 516 as an input parameter. In this example, the frame type class also offers a static “max length” method that can be invoked to determine a maximum length associated with a frame type. It should be noted that some protocols (e.g., HTTP/3) dictate that protocol frames with unknown frame types can be ignored; therefore, the payload of an outgoing frame 516 with an unknown frame type can safely be discarded in some scenarios. As used herein, the phrase “discarding a dataset” refers to rendering memory space allocated for storing that dataset eligible for reclamation. In an example, an outgoing frame 516 is manifested in managed memory area 510 as an unknown frame by an instance of an unknown frame class. In this example, the unknown frame class is a subclass of a partial frame class.

In an embodiment, an outgoing frame 516 is modeled as a malformed frame. An outgoing frame 516 may be modeled as a malformed frame if the outgoing frame 516 is found to possess some malformity. An example malformed frame includes (a) frame metadata of an outgoing frame 516 and (b) an error code indicating a malformity associated with the outgoing frame 516. A malformed frame can be used to trigger a protocol error that will (a) terminate a stream, (b) terminate a network connection that is used to establish the stream, and/or (c) cause other actions. In an example, an outgoing frame 516 is manifested in managed memory area 510 as a malformed frame as an instance of a malformed frame subclass.

In an embodiment, a stream reader 518 is a mechanism for processing incoming stream data. A stream reader 518 is configured to process incoming stream data by manipulating incoming frames 512, buffers 514, and/or other information. A stream reader 518 is configured for parsing incoming frames 512 associated with a particular protocol, or the stream reader 518 is configured for parsing incoming frames 512 that are associated with multiple protocols. A stream reader 518 is configured for parsing incoming frames 512 associated with a single stream, or the stream reader 518 is configured for parsing the incoming frames 512 of multiple streams. In an example, a stream reader 518 is configured to obtain incoming frames 512 from a remote peer, transmit the incoming frames 512 to a stream organizer 520, receive the incoming frames 512 transmitted back to the stream reader 518 by the stream organizer 520, present the payloads of incoming frames 512 in a queue of buffers 514, trigger a read loop 522 to consume the payloads presented in the queue of buffers 514, and perform other operations.

In an embodiment, a stream reader 518 is a runtime object that is related to a stream reader reference type. As an example, assume that incoming frames 512 are QUIC frames. In this example, a stream reader 518 is an instance of a QUIC receiver stream implementation class. The QUIC receiver stream implementation class of this example extends a QUIC stream class, and the QUIC stream class implements a QUIC receiver stream interface.

In an embodiment, a stream reader 518 maintains a queue of buffers 514. A queue of buffers 514 maintained by a stream reader 518 includes buffers 514 that store payloads of incoming frames 512. In particular, the buffers 514 listed in a queue of buffers 514 correspond to incoming frames 512 that the stream organizer 520 has transmitted back to the stream reader 518 in an ordered flow. In other words, the buffers 514 listed in this queue correspond to incoming frames 512 that the stream organizer 520 has released for further processing. In an example, a stream reader 518 organizes a queue of buffers 514 according to the same order that a stream organizer 520 transmits the corresponding incoming frames 512 back to the stream reader 518.

In an embodiment, a stream reader 518 provides methods for interacting with incoming frames 512, buffers 514, and other information. For example, a stream reader 518 may provide a method for processing incoming frames, a method for polling buffers 514 from an ordered queue of buffers 514 maintained by the stream reader 518, and other methods.

In an embodiment, stream organizer 520 is a mechanism for organizing stream data. Stream organizer 520 is configured to organize stream data by manipulating incoming frames 512 and/or other information. Stream organizer 520 is configured for parsing incoming frames 512 associated with a particular protocol, or stream organizer 520 is configured for parsing incoming frames 512 associated with multiple protocols. Stream organizer 520 is configured for parsing incoming frames 512 associated with a single stream, or stream organizer 520 is configured for parsing incoming frames 512 of multiple streams. In an example, a stream organizer 520 is configured to receive incoming frames 512 from a stream reader 518, and the stream organizer 520 is configured to transmit the incoming frames 512 back to the stream reader 518 in an ordered flow. The stream organizer 520 of this example is configured to organize the incoming frames 512 by reordering the incoming frames 512, discarding duplicate incoming frames 512, and eliminating overlaps between incoming frames 512.

In an embodiment, a stream organizer 520 provides methods for manipulating incoming frames 512, buffers 514, and/or other information. For example, a stream organizer 520 may provide a method for receiving incoming frames 512, a method for polling incoming frames 512 from the stream organizer 520 that the stream reader 518 may call to obtain any frame payload that is ready for delivery, a method for extracting frame offsets, a method for extracting frame lengths, a method for slicing incoming frames 512, a method for allocating new incoming frames 512, and other methods. A method of a stream organizer 520 may invoke another method on a buffer 514, an incoming frame 512, another runtime object, or a reference type (i.e., a static method). As an example, assume that a stream organizer 520 provides a slice method. The slice method of this example accepts one incoming frame 512 as an input parameter, and the slice method returns a new incoming frame 512 that can be used to replace the one incoming frame 512. In this example, calling the slice method on the stream organizer 520 may trigger the invocation of a slice method on a buffer 514 that represents a payload of the one incoming frame 512. The slice method of the buffer 514 will return a new buffer 514 that represents a portion of the one incoming frame's 512 payload, and the new incoming frame 512 will refer to the new buffer 514 in this example.

In an embodiment, stream organizer 520 offers a method that is configured to selectively replace incoming frames 512. In particular, the method is configured to generate a new incoming frame 512 to replace an existing incoming frame 512 if part of the data delivered to the system 500 by the existing incoming frame 512 is extraneous. There are multiple ways that a new incoming frame 512 can be created. Accordingly, the method offered by stream organizer 520 is configured to create a new incoming frame 512 in a manner that bests suits the present circumstances.

In an embodiment, a method of stream organizer 520 is configured to replace (a) an incoming frame 512 and buffer 514 that stores the incoming frame's 512 payload with (b) a new incoming frame 512 and a new buffer 514 that stores the new incoming frame's 512 payload. As an example, consider an original incoming frame 512 and an original buffer 514 that stores the original incoming frame's 512 payload. In this example, a method of stream organizer 520 instantiates a new incoming frame 512 to replace the original incoming frame 512, and the method of stream organizer 520 instantiates a new buffer 514 by either (a) slicing the original buffer 514 or (b) partitioning the original buffer 514. To slice the original buffer 514 in this example, the method of stream organizer 520 is configured to call a slice method on the original buffer 514. To partition the original buffer 514 in this example, the method of stream organizer 520 is configured to call an allocate method on the original buffer 514.

In an embodiment, a stream organizer 520 maintains an ordered queue of frames 512 and a flow offset. An ordered queue of frames 512 maintained by a stream organizer 520 holds incoming frames 512 that are not yet ready to be returned to a stream reader 518 for further processing. A flow offset tracked by a stream organizer 520 is an indicator of the incoming frames 512 of a stream that have been returned by the stream organizer 520 to a stream reader 518 thus far. In general, a stream organizer 520 is configured to return an incoming frame 512 to a stream reader 518 when the frame offset of that incoming frame 512 matches the flow offset maintained by the stream organizer 520. When a stream organizer 520 receives an incoming frame 512 that indicates a frame offset that is greater than a current flow offset, the stream organizer 520 may add that incoming frame 512 to an ordered queue of frames 512 maintained by the stream organizer 520. When a stream organizer 520 transmits an incoming frame 512 back to a stream reader 518, the stream organizer 520 is configured to increment a flow offset commensurate to a frame length indicated by that incoming frame 512.

In an embodiment, a stream organizer 520 is a runtime object that is related to an ordered flow reference type. As an example, assume that the ordered flow reference type is an ordered flow class, and further assume that incoming frames 512 are QUIC frames. The QUIC frames of this example may include crypto frames, stream frames, and other types of QUIC frames. In this example, the ordered flow class implements a QUIC frame class, and the stream organizer 520 is an instance of a subclass that extends the ordered flow class. For instance, the stream organizer 520 of this example may be an instance of a crypto data flow class that extends the ordered flow class, an instance of a stream data flow class that extends the ordered flow class, or an instance of another subclass that extends the ordered flow class. In this embodiment, a flow offset for a stream is stored to an object field of a stream organizer 520, and an ordered queue of frames maintained by the stream organizer 520 may be a separate runtime object that is manipulated by the stream organizer 520. For example, an ordered queue of frames may be manifested as an instance of a concurrent skip list set class.

In an embodiment, a read loop 522 is a mechanism for processing outgoing stream data. A read loop 522 is configured to process outgoing stream data by manipulating outgoing frames 516, buffers 514, and/or other information. A read loop 522 is configured for processing outgoing frames 516 associated with a particular protocol, or the read loop 522 is configured for parsing outgoing 516 frames associated with multiple protocols. A read loop 522 is configured for processing the outgoing frames 516 of a single stream, or the read loop 522 is configured for processing the outgoing frames 516 of multiple streams.

In an embodiment, a read loop 522 is a runtime object that is related to a read loop reference type. As an example, assume that outgoing frames 516 are manifestations of HTTP/3 frames. In this example, the read loop is an instance of an HTTP/3 exchange implementation class, and the HTTP/3 implementation class extends an HTTP/3 stream class.

In an embodiment, a read loop 522 provides method(s) for processing stream data. An example method offered by a read loop 522 for processing stream data is configured to (a) facilitate the processing of stream data by other components of system 500 and (b) deliver the processed stream data to stream recipient(s). For instance, the example method for processing stream data may be configured to (a) poll buffers 514 from a queue of buffers 514 maintained by a stream reader 518, (b) submit the polled buffers 514 to a frames decoder 524 for decoding, (c) poll the frames decoder 524 for outgoing frames 516 decoded by the frames decoder 524, (d) query the frames decoder 524 for payload data of a decoded partial frame, (e) deliver decoded data of outgoing frames 516 to stream recipient(s), and/or (f) perform other operations. Data of an outgoing frame 516 that may be delivered to a stream recipient by the example method for processing stream data may include (a) payload data of the outgoing frame 516, (b) frame metadata of the outgoing frame 516, (c) and/or other information (e.g., an error code associated with a malformed frame). The example method for processing stream data may be configured to identify an appropriate stream recipient for decoded data of an outgoing frame 516 based on (a) the frame type of the outgoing frame 516, (b) how the outgoing frame 516 is modeled (e.g., partial frame, complete frame, malformed frame, etc.), (c) the content of the outgoing frame 516, and (d) other information.

In an embodiment, a read loop 522 offers a method for processing stream data, and the method for processing stream data is configured to deliver stream data to stream recipient(s). In an example, incoming frames 512 are QUIC frames that embed HTTP/3 frames (i.e., outgoing frames 516). In this example, a read loop 522 offers a “process QUIC data” method, and the process QUIC data method is configured to deliver stream data to one or more stream recipients. Stream recipient(s) of this example may include an HTTP response subscriber, a connection handler, a stream manager, a connection-level push handler, and others. Typically, if an outgoing frame 516 is an HTTP/3 data frame, the process QUIC data method of this example will attempt to deliver payload data of the HTTP/3 data frame to one or more HTTP response subscribers. Example HTTP response subscribers include web browsers, API clients, media players, server-sent events clients, web sockets, file downloaders, machine learning pipelines, and others. The process QUIC data method of this example is configured to deliver payload data of an HTTP/3 data frame to an HTTP response subscriber by (a) adding that payload data to a queue of stream data and (b) pushing the data in the queue of stream data to the HTTP response subscriber. In this example, the queue of stream data is manifested in managed memory area 510 as an instance of a concurrent linked queue class, and payload data of an HTTP/3 data frame is manifested in managed memory area 510 as a list of byte buffers (e.g., an instance of a class that implements a list interface). In this example, the concurrent linked queue instance offers an “add” method, and the process method of the read loop 522 is configured to add the stream data to the queue of stream data by invoking the add method on the concurrent linked queue instance while specifying a list of byte buffers as an input parameter. Furthermore, in this example, read loop 522 offers a “push response data” method that is configured to push data in the queue of stream data to an HTTP response subscriber if that HTTP response subscriber is ready to consume that data. After adding the stream data to the queue of stream data in this example, the process QUIC data method is configured to invoke the push response data method of the read loop 522.

In an embodiment, a frames decoder 524 is a mechanism for decoding stream data. In particular, a frames decoder 524 is a mechanism for decoding stream data delivered to the system in incoming frames 512. For instance, a frames decoder 524 may extract outgoing frames 516 from the payloads of incoming frames 512. To this end, a frames decoder 524 is configured to manipulate buffers 514, a buffers reader 526, and/or other information. A frames decoder 524 is configured for extracting outgoing frames 516 associated with a particular protocol, or the frames decoder 524 is configured for extracting outgoing frames 516 associated with multiple protocols. A frames decoder 524 is configured for extracting outgoing frames 516 of a single stream, or the frames decoder 524 is configured for extracting outgoing frames 516 of multiple streams. In an example, a frames decoder 524 is configured to accept buffers 514 from read loop 522, submit the buffers 514 to a buffers reader 526, decode stream data aggregated by the buffers reader 526 to generate outgoing frames 516, and transmit the outgoing frames 516 to the read loop 522.

In an embodiment, a frames decoder 524 provides methods for manipulating buffers 514, outgoing frames 516, and/or other information. For example, a frames decoder 524 may provide a method for submitting buffers 514 to the frames decoder 524, a method for polling outgoing frames 516 from the frames decoder 524, a method for retrieving data from a buffers reader 526, and other methods. An example poll method called on a frames decoder 524 returns a complete frame, a partial frame, an unknown frame, a malformed frame, or another variety of outgoing frame 516. The example poll method may call a static decode method of an outgoing frame reference type (e.g., an outgoing frames interface).

In an embodiment, a frames decoder 524 is a runtime object that is related to a frames decoder reference type. In an example, a frames decoder 524 is an instance of a frames decoder class. The frames decoder 524 of this example may be created by calling a static method of the frames decoder class.

In an embodiment, a frames decoder 524 maintains variable(s) for tracking the decoding of a stream. An example frames decoder 524 maintains a partial frame instance variable. The partial frame instance variable of the example frames decoder 524 indicates if there is an outgoing frame 516 modeled as a partial frame that is currently being decoded. Typically, the partial frame instance variable is either (a) set to reference an outgoing frame 516 modeled as a partial frame or (b) set to null. If the partial frame instance variable refers to an outgoing frame 516 in this example, that outgoing frame 516 is the partial frame that is currently being decoded. Alternatively, if the partial frame instance variable is set to null in this example, there is no partial frame that is currently being decoded. An outgoing frame 516 that is referenced by a partial frame instance variable of a frames decoder 524 is referred to herein as a “current partial frame.”

In an embodiment, a frames decoder 526 offers method(s) for retrieving elements that encode the payload of an outgoing frame 516. An example frames decoder 526 offers a “read payload bytes” method that can be used to retrieve undelivered payload data of an outgoing frame 516 modeled as a partial frame. If the payload of an outgoing frame 516 that is the current partial frame has not been fully decoded when the read payload bytes method is invoked, the read payload bytes method is configured to return the undelivered bytes encoding the payload that are presently available for decoding. The read payload bytes method is configured to return these bytes as a list of byte buffer(s).

In an embodiment, a buffers reader 526 is a mechanism configured to act as an abstraction of one or more buffers 514. While serving as an abstraction of buffer(s) 514, a buffers reader 526 presents the elements represented by those buffer(s) 514 as a continuous sequence of element(s) that can be accessed and manipulated through the buffers reader 526. A buffers reader 526 is configured to serve as an abstraction of a particular variety of buffers 514 (e.g., a byte buffers 514), or a buffers reader 526 is configured to serve as an abstraction of multiple varieties of buffers 514. A buffers reader 526 is a single buffers reader 526, or the buffers reader 526 is a list buffers reader 526. As the name suggests, a single buffers reader 526 is configured to act as an abstraction of a single buffer 514. A list buffers reader 526 is configured to act as an abstraction of one or more buffers 514. A list buffers reader 526 maintains a list of abstracted buffers 514, and the list buffers reader 526 acts as an abstraction of any buffers 514 that are entered into the list.

In an embodiment, a buffers reader 526 is a runtime object that is related to a buffers reader reference type. A buffers reader reference type and/or subclasses of the buffers reader reference type define methods (e.g., factory methods, constructors, etc.) that can be invoked to create a buffers reader 526. In an example, the buffers reader reference type is an abstract buffers reader class, and a buffers reader 526 is an instance of a subclass that extends the abstract buffers reader class. In particular, the buffers reader 526 of this example is an instance of a single buffers reader subclass that extends the buffers reader class, or the buffers reader 526 is an instance of a list buffers reader subclass that extends the buffers reader class.

In an embodiment, a buffers reader 526 acting as an abstraction of buffer(s) 514 presents elements represented by those buffer(s) 514 as a continuous sequence of element(s) that are consecutively indexed. An example continuous sequence of elements is indexed by a buffers reader 526 starting from zero. The index assigned to an element by a buffers reader 526 is referred to herein as the “global position” of that element. It should be noted that the indexing of an element by a buffers reader 526 may differ from how that same element is indexed by (a) a buffer 514 that represents that element and/or (b) an underlying data structure that stores that element. In other words, the global position of an element may differ from (a) the relative position of that element and/or (b) the local position of that element. A differential between the global position of an element and the relative position of the element is referred to herein as an “index differential.” For example, a differential between an index value assigned to an element by a buffers reader 526 and an index value assigned to that same element by a buffer 514 that is aggregated by the buffers reader 526 may be identified herein as the “index differential” of that buffer 514.

In an embodiment, a buffers reader 526 is a list buffers reader 526, and the buffers reader 526 maintains a list of abstracted buffers 514. An entry in a list of abstracted buffers 514 may record attributes of the buffer 514 corresponding to that entry. An example list of abstracted buffer 514 is indexed starting from zero where list index zero corresponds to the leading entry in the example list of abstracted buffers 514. It should be noted that the indexing of entries in a list of abstracted buffers 514 is separate from the indexing of elements in a continuous sequence of elements. An example entry in a list of abstracted buffers 514 is an instance of a record class, and the example entry includes (a) a reference to a buffer 514 that corresponds to the example entry, (b) an initial read position of that buffer 514, (c) a limit of that buffer 514, and/or (d) other information. Generally, the initial read position of a buffer 514 entered in a list of abstracted buffers 514 is the read position of that buffer 514 at the time that buffer 514 is entered into the list; however, this may not always be the case. For example, the leading entry in a list of abstracted buffers 514 may record the initial read position of the corresponding buffer 514 as zero even if the true read position of that buffer 514 is not zero at the time the buffer 514 is entered into the list. It should be noted that whether or not a buffer 514 entered into a list of abstracted buffers 514 possesses an index differential greater than zero may depend on where that buffer 514 is entered within the list. A preceding buffer 514 in a list of abstracted buffers 514 will typically contribute to the index differential of a latter buffer 514 in the list. As used herein, the “relative offset” of a buffer 514 included in a list of abstracted buffers 514 refers to an increase in the index differential of that buffer 514 that results from any other buffers 514 that precede that buffer 514 in the list. A relative offset is not the sole factor that may contribute to the index differential of a buffer 514 entered in a list of abstracted buffers 514. For instance, the initial read position of a buffer 514 when that buffer 514 is entered into a list of abstracted buffers 514 may also impact an index differential of that buffer 514. As an example, consider a buffer 514 that is entered into a list of abstracted buffers 514, and assume that there are other buffers 514 that precede the newly added buffer 514 in the list. If the buffer 514 is partially read when the buffer 514 is entered into the list of abstracted buffers 514 in this example, the buffers reader 526 may exclude the read elements of that buffer 514 from a continuous sequence of elements that is presented by the buffers reader 526. Elements excluded from the continuous sequence of elements by the buffers reader 526 in this example are not indexed by the buffers reader 526. As a result, the index differential of that buffer 514 may be altered by an amount corresponding to the read position of the buffer 514 when that buffer 514 is entered into the list of abstracted buffers 514 in this example (i.e., the initial read position of that buffer 514).

In an embodiment, a buffers reader 526 maintains variable(s) that track characteristics of (a) the buffers reader 526, (b) any buffers 514 abstracted by the buffers reader 526, and/or (c) elements included in a continuous sequence of elements presented by the buffers reader 526. Example variables that may be maintained by a buffers reader 526 include (a) a start position, (b) a read position, (c) a limit, (d) a current pointer, (e) a current offset, (f) a next index, (g) a read and released counter, (h) a capacity, and (i) others. The start position of a buffers reader 526 is the global position of the first element in a continuous sequence of elements that is accessible through the buffers reader 526. A buffers reader 526 may deny a request that attempts to retrieve an element residing before the buffers reader's 526 start position. The read position of a buffers reader 526 indicates the global position of an element in a continuous sequence of elements presented by the buffers reader 526. In particular, the read position of a buffers reader 526 indicates the global position of the element that should be read next. The limit of a buffers reader 526 is the global position of the first element that is inaccessible through the buffers reader 526. For example, if the limit of a buffers reader 526 is twenty, the last element that should be accessible through the buffers reader 526 resides at global position nineteen. The current pointer of a buffers reader 526 may hold a reference to a buffer 514 in a list of abstracted buffers 514 maintained by the buffers reader 526. A buffer 514 that is referenced by the current pointer of a buffers reader 526 is referred to herein as a “current buffer” 514. If a current pointer of a buffers reader 526 is not set to null, the current pointer will typically reference the buffer 514 that represents the element residing at the read position of the buffers reader 526. In other words, the current buffer 514 of a buffers reader 526 is typically the buffer 514 that is currently being read through the buffers reader 526. The current offset of a buffers reader 526 is the relative offset of the buffers reader's 526 current buffer 514. The current offset of a buffers reader 526 may change whenever the current buffer 514 of the buffers reader 526 changes. If the current pointer of a buffers reader 526 is not set to null (i.e., there is a current buffer 514), the next index of the buffers reader 526 indicates the entry in a list of abstracted buffers 514 that immediately follows the current buffer's 514 entry in the list. The read and released counter of a buffers reader 526 measures the number of elements that have been read through the buffers reader 526 and released from the continuous sequence of elements presented by the buffers reader 526. The capacity of the buffers reader 526 is the number of elements presently included in a continuous sequence of elements presented by the buffers reader 526. In an example, variable(s) of a buffers reader 526 are larger than comparable variable(s) that are maintained by a buffer 514. For instance, the read position and limit of an example buffers reader 526 may be longs, whereas the read position and limit of an example buffer 514 may be integers.

In an embodiment, a buffers reader 526 offers method(s) for retrieving and/or altering variables that are maintained by the buffers reader 526. For example, a buffers reader 526 may offer methods that return or alter (a) a start position of the buffers reader 526, (b) a read position of the buffers reader 526, (c) a limit of the buffers reader 526, (d) a current offset of the buffers reader 526, (e) a current pointer of the buffers reader 526, (f) a next index of the buffers reader 526, (g) a read and released counter, and/or (h) other information. In general, a method that alters a variable of a buffers reader 526 may also alter a method of a buffer 514 that is abstracted by the buffers reader 526. For example, a change to the read position of a buffers reader 526 may be accompanied by a corresponding change to the read position of buffer(s) 514 that are abstracted by the buffers reader 526. A method of a buffers reader 526 may alter a variable of a buffer 514 by invoking a method offered by the buffer 514.

In an embodiment, a buffers reader 526 offers methods for adding a buffer 514 to the buffers reader 526. Once a buffer 514 is added to a buffers reader 526, that buffers reader 526 acts as an abstraction of that buffer 514. An example buffers reader 526 offers an “add” method that is configured to (a) accept a buffer 514 as an input parameter and (b) enter that buffer 514 into a list of abstracted buffers 514 maintained by the buffers reader 526. The example buffers reader 526 also offers an “add all” method that is configured to (a) accept a list of buffers 514 as an input parameter and (b) enter the buffers 514 in the list of buffers 514 into a list of abstracted buffers 514 maintained by the buffers reader 526.

In an embodiment, a buffers reader 526 offers method(s) for reading element(s). As used herein, the phrase “reading through a buffers reader” 526 refers to retrieving elements(s) that are included in a continuous sequence of elements presented by the buffers reader 526 and recording those element(s) as being read. An example buffers reader 526 offers a relative “get” method that is configured for reading through the buffers reader 526. If invoked, the relative get method is configured to (a) return the element residing at the read position of the example buffers reader 526 and (b) increment the read position of the example buffers reader 526 by one element. For instance, if the example buffers reader 526 aggregates byte buffers 514, the relative get method is configured to (a) return the byte residing at the read position of the example buffers reader 526 and (b) increment the read position of the example buffers reader 526 by one byte.

In an embodiment, a buffers reader 526 offers method(s) for peeking elements. As used herein, the phrase “peeking through a buffers reader” 526 refers to retrieving element(s) from a continuous sequence of elements presented by the buffers reader 526 without marking those element(s) as read. An example buffers reader 526 offers an absolute “get” method that can be used to peek an element residing at a global position that is specified as an input parameter. The absolute get method does not alter the read position of the example buffers reader 526. Recall that a buffers reader 526 may offer a method for altering the read position of the buffers reader 526. If appropriate, a component of the system can mark an element as read after peeking that element through a buffers reader 526 by altering the buffers reader's 526 read position.

In an embodiment, a buffers reader 526 offers method(s) for releasing elements from a continuous sequence of elements presented by the buffers reader 526. An example buffers reader 526 provides a “release” method that is configured to (a) release any read elements from a continuous sequence of elements, (b) reset the read position of the example buffers reader 526 to zero, and (c) set the limit of the example buffers reader 526 to the remaining number of elements in the continuous sequence of elements. The example buffers reader 526 also offers a “clear” method that is configured to release all elements included in the continuous sequence of elements presented by the example buffers reader 526.

In an embodiment, a buffers reader 526 offers method(s) for (a) reading element(s) included in a continuous sequence of elements presented by the buffers reader 526 and (b) releasing the element(s) that are read. An example buffers reader 526 offers a “get and release” method. The get and release method accepts a number of elements as an input parameter, and the get and release method is configured to (a) return that number elements starting with the element residing at the read position of the example buffers reader 526, (b) release those elements that are returned, (c) set the read position of the buffers reader 526 to zero, and (d) update the limit of the buffers reader 526 to reflect the remaining number of elements included in a continuous sequence of elements presented by the example buffers reader 526.

In an embodiment, a buffers reader 526 offers method(s) for determining the status of information presented by the buffers reader 526. For instance, among other methods, an example buffers reader 526 offers a “has remaining” method, a “remaining” method, and an “is empty” method. The has remaining method is a Boolean method that returns true if a sequence of elements presented by the example buffers reader 526 includes at least one unread element. The remaining method of the example buffers reader 526 is an integer method that returns the number of unread elements included within a continuous sequence of elements presented by the example buffers reader 526. The is empty method of the example buffers reader 526 is a Boolean method that returns true if the buffers reader 526 is not presently acting as an abstraction for any buffer 514.

In an embodiment, a buffers reader 526 offers method(s) for writing to element(s) included in a continuous sequence of elements presented by the buffers reader 526. An example buffers reader 526 provides a relative “put” method. The relative put method accepts an element as an input parameter, and the relative put method is configured to (a) write the element at the read position of the example buffers reader 526 and (b) increment the read position of the example buffers reader 526. The example buffers reader 526 also offers an absolute “put” method. The absolute put method of the example buffers reader 526 accepts a global position and an element as input parameters, and the absolute put method is configured to write the element to the global position.

In an embodiment, a buffers reader 526 offers a getter method for retrieving the read position of the buffers reader 526, and the buffers reader 526 offers a setter method for moving the read position of the buffers reader 526. An example buffers reader 526 offers a “position” method that is configured to return the read position of the example buffers reader 526, and the example buffers reader 526 offers another “position” method that is configured to move the read position of example buffers reader 526 to a relative position that is specified as an input parameter.

In an embodiment, a buffers reader 526 offers a getter method for retrieving the limit of the buffers reader 526, and the buffers reader offers a setter method for altering the limit of the buffers reader 526. An example buffers reader 526 offers a “limit” method that returns the limit of the example buffers reader 526, and the example buffers reader 526 offers another “limit” method that is configured to move the limit of the example buffers reader 526 to a relative position that is specified as an input parameter.

In an embodiment, system 500 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. PARSING STREAM DATA

FIG. 6 illustrates an example set of operations for parsing stream data in accordance with one or more embodiments. One or more operations illustrated in FIG. 6 may be modified, rearranged, or omitted. Accordingly, the particular sequence of operations illustrated in FIG. 6 should not be construed as limiting the scope of one or more embodiments.

In an embodiment, a stream reader obtains incoming frames, and the stream reader transmits the incoming frames to a stream organizer (Operation 602). The incoming frames embed outgoing frames. More specifically, at least some of the incoming frames are frames that carry higher-level protocol binary payloads, and at least some of these payloads encode outgoing frames. The payload of an incoming frame may encode a portion of an outgoing frame, an entire outgoing frame, and/or multiple outgoing frames. If an incoming frame carries a payload, the payload may be stored to a buffer of the system. The incoming frames also include frame metadata (e.g., frame types, stream IDs, frame offsets, frame lengths, etc.) that the system uses to parse the incoming frames. The incoming frames are delivered to the system through a network connection. Stream data transported through a network connection may get lost, may be partially retransmitted, and/or may be duplicated. Accordingly, the stream reader may obtain the incoming frames in an incorrect order, and the incoming frames obtained by the stream reader may include overlapping frames and duplicate frames. The stream reader transmits the incoming frames to the stream organizer in a sequence and condition that is congruent to the sequence and condition that the incoming frames are obtained by the stream reader. Accordingly, the incoming frames may be transmitted to the frames organizer out of order, and the incoming frames transmitted to the stream organizer may include overlapping frames and duplicate frames. The stream reader relies on the stream organizer to transmit the incoming frames back to the stream reader in an ordered flow of incoming frames that includes neither duplicate frames nor overlapping frames. In an example, the stream reader provides a process incoming frame method, and the stream organizer provides a receive method. In this example, the stream reader obtains an incoming frame as a result of a remote peer calling the process incoming frame method on the stream reader while specifying the incoming frame as an input parameter. While performing the process incoming frame method in this example, the stream reader, in turn, transmits the incoming frame to the stream organizer by calling the receive method on the stream organizer while specifying the incoming frame as an input parameter. Typically, in this example, the receive method of the stream organizer will return an incoming frame that is ready for further processing, or the receive method will return null. If the receive method returns an incoming frame in this example, that incoming frame is the same incoming frame that was specified as an input parameter while invoking the receive method, or that incoming frame is a different incoming frame. In addition to the receive method, the stream reader of this example can request incoming frames from the stream organizer by calling a poll method that is provided by the stream organizer.

Recall that a protocol (e.g., the QUIC Protocol) may permit multiple streams to be established over a single network connection. Accordingly, in an embodiment, any given incoming frame that is received by the system could belong to any one of multiple streams that are established over a single network connection. If multiple streams are established over a network connection, the system may rely on multiple stream readers, stream organizers, read loops, frames decoders, and buffers readers for parsing the multiple streams. In an example, at least one dedicated stream reader, stream organizer, read loop, frames decoder, and buffers reader is created for each stream. However, in other examples, component(s) of the system are configured to parse stream data associated with multiple streams. For instance, in another example, a stream reader is configured to receive incoming frames belonging to multiple streams. The system is configured to dispatch any given incoming frame to the appropriate stream reader based on a stream ID and/or other frame metadata that is included in the incoming frame. If no presently existing stream reader is responsible for parsing the incoming frames associated with a stream, the system may create a new stream reader for that stream, and the system may create other components (e.g., a stream organizer, a read loop, a frames decoder, a buffers reader, etc.) for that stream as needed.

Multiple protocols may influence how the incoming frames are transmitted to the system. For instance, in an embodiment, the incoming frames are associated with at least one lower-layer protocol (e.g., a transport-layer protocol), and the outgoing frames are associated with at least one higher-layer protocol (e.g., an application-layer protocol). Depending on the protocols in play, the outgoing frames may have been arbitrarily split and segmented before being encoded into the payloads of the incoming frames that are delivered to the system through the network connection. The lower-layer frames are delivered to the system packaged within lower-layer packets. A lower-layer packet may include a portion of a lower-layer frame, the entirety of a lower-layer frame, and/or multiple lower-layer frames. If a lower-layer packet includes multiple lower-layer frames (i.e., in whole or in part), the multiple lower-layer frames may belong to the same stream, or the multiple lower-layer frames may belong to different streams. The payloads of the lower-layer frames include the higher-layer frames. A payload of a lower-layer frame may include a portion of a higher-layer frame, the entirety of a higher-layer frame, and/or multiple higher-layer frames.

In an embodiment, the stream organizer organizes the incoming frames, and the stream organizer transmits the incoming frames back to the stream reader in an ordered flow (Operation 604). The stream organizer organizes the incoming frames by reordering incoming frames, replacing incoming frames, discarding incoming frames, and/or performing other operations. To organize the incoming frames of a stream, the stream organizer maintains a flow offset for that stream, and the stream organizer maintains an ordered queue of frames that cannot yet be transmitted back to the stream reader. The flow offset indicates a specific position (e.g., an address of a byte) within the stream; any stream data preceding the flow offset is included within the payloads of incoming frames that have already been transmitted by the stream organizer back to the stream reader (i.e., released for further processing). Based on the flow offset and frame metadata held by the incoming frames (e.g., frame offsets and frame lengths), the stream organizer identifies unordered incoming frames, overlapping incoming frames, and/or duplicate incoming frames. Recall that the frame offset of an incoming frame indicates the starting position of the incoming frame's payload in a stream, and the frame length of the incoming frame indicates the size of the payload. In general, the stream organizer transmits an incoming frame back to the stream reader if the frame offset of that incoming frame matches the flow offset for that stream. When the stream organizer transmits an incoming frame back to the stream reader, the stream organizer advances the flow offset commensurate to the frame length indicated by that incoming frame. In an example, the stream organizer returns an incoming frame to the stream reader responsive to the stream reader calling a receive method on the stream organizer, and/or the stream organizer returns an incoming frame to the stream reader responsive to the stream reader calling a poll method on the stream organizer.

In an embodiment, the stream organizer adds an incoming frame to an ordered queue of frames maintained by the stream organizer if the incoming frame cannot yet be transmitted back to the stream reader. In particular, an incoming frame is added to an ordered queue if (a) the frame offset of the incoming frame is greater than the flow offset of the corresponding stream, (b) the incoming frame is not a duplicate of another incoming frame that is already in the ordered queue, and (c) the incoming frame does not overlap with another incoming frame that is already in the ordered queue. In an example, the stream organizer organizes the ordered queue according to the frame offsets held by the incoming frames that are constituents of the ordered queue. In this example, an incoming frame with an inferior frame offset appears in the ordered queue before another incoming frame with a greater frame offset. When the stream organizer advances the flow offset, the stream organizer may also check if the advancement of the flow offset has rendered a leading frame in the ordered queue (i.e., an incoming frame listed at the front of the ordered queue) eligible for transmission back to the stream reader. In particular, the stream organizer may check if a newly-advanced flow offset matches the frame offset of the leading frame in the ordered queue.

In an embodiment, if an incoming frame delivers a payload that is partially extraneous, the stream organizer replaces the incoming frame with a new frame having a new payload. The new payload of the new frame (a) includes relevant data delivered by the incoming frame and (b) excludes the extraneous data delivered by the incoming frame. To make better use of the system's available resources, the stream organizer selects an approach for creating the new frame based on the circumstances. For instance, the stream organizer may choose to create the new frame by slicing the incoming frame, to minimize the computational cost of creating the new frame. Alternatively, the stream organizer may choose to create the new frame by partitioning the incoming frame, to reduce the amount of memory space that is occupied by the new frame while the system is processing the new frame. If the stream organizer creates the new frame by slicing the incoming frame, the amount of memory space that is occupied by the new frame includes both (a) the memory space allocated for storing the relevant information delivered by the incoming frame and (b) the memory space allocated for storing the extraneous information delivered by the incoming frame. Accordingly, if the incoming frame is sliced, the system is delayed from reclaiming the memory space allocated for the extraneous information until after the new frame is fully processed. In comparison, if the stream organizer creates the new frame by partitioning the incoming frame, the amount of memory space occupied by the new frame does not include the memory space allocated for the extraneous information. Accordingly, if the incoming frame is partitioned, the system is typically allowed to reclaim the memory space allocated for the extraneous information shortly after the new frame is created.

In an embodiment, the stream organizer eliminates an overlap between incoming frames by generating a new frame to replace an incoming frame that overlaps with another incoming frame. As an example, consider an incoming frame that overlaps with another incoming frame. In particular, the payload of the incoming frame overlaps with the payload of the other incoming frame in this example. For the purposes of this example, assume that the other incoming frame has already been transmitted back to the stream reader or is currently residing in the ordered queue. Accordingly, the stream organizer generates a new frame to replace the incoming frame in this example. The stream organizer of this example determines a frame offset, a frame length, and other attributes of the new frame. The frame offset and frame length of the new frame reflect the position and size of the non-overlapping portion of the incoming frame's payload in this example. The frame offset of the new frame is the same as the frame offset of the incoming frame (e.g., if a trailing portion of the original payload overlaps with the other payload), or the frame offset of the new frame is different than the frame offset of the incoming frame (e.g., if a leading portion of the original payload overlaps with the other payload). Furthermore, the stream organizer of this example invokes a method on the buffer that represents the payload of the incoming frame (e.g., a slice method, an allocate method, etc.), and the other method provides instructions for creating a new buffer to represent the non-overlapping portion of the incoming frame's payload. After generating the new frame and the new buffer, the new frame is either promptly returned to the stream organizer or added to the ordered queue depending on the frame offset of the new frame relative to the current flow offset. The original incoming frame is subsequently discarded.

In an embodiment, the stream reader receives the incoming frames transmitted from the stream organizer, and the stream reader presents the payloads of the incoming frames to a read loop in a queue of buffers (Operation 606). The buffers in the queue of buffers store the payloads of the incoming frames. The stream reader adds a buffer to the queue of buffers when a corresponding incoming frame is transmitted back to the stream reader by the stream organizer. Buffers are presented within the queue of buffers according to the sequence that the corresponding incoming frames are transmitted back to the stream reader by the stream organizer. Recall that the stream organizer transmits the incoming frames back to the stream reader in an ordered flow. Therefore, the order of the buffers in the queue of buffers accords to the correct sequence that the payloads stored to the buffers are intended for delivery within the stream. In an example, the payloads of the incoming frames carry binary stream data, and the buffers storing the payloads are byte buffers. In this example, the stream reader is effectively translating the ordered flow of frames returned by the stream organizer into an ordered flow of bytes that is presented by the queue of byte buffers. If the queue of buffers accumulates a sufficient number of buffers for consumption by the read loop, the stream reader may trigger the consumption of the buffers by the read loop. In an example, the stream reader triggers the read loop by invoking a read loop method on the read loop. If the queue of buffers includes an insufficient number of buffers for consumption by the read loop, the stream reader may continue to transmit incoming frames to the stream organizer, and/or the stream reader may poll the stream organizer for additional incoming frames.

In an embodiment, the read loop retrieves the buffers that are presented in the queue of buffers maintained by the stream reader, and the read loop transmits the buffers to a frames decoder (Operation 608). Recall that the buffers store payloads of incoming frames, and the payloads of the incoming frames encode outgoing frames. The read loop relies on the frames decoder to decode the stream data that is carried by these payloads. In other words, the read loop is relying on the frames decoder to extract the outgoing frames from the payloads of the incoming frames represented by the buffers. The read loop transmits the buffers to the frames decoder in the sequence that the buffers are presented in the queue of buffers. Further recall that the queue of buffers is ordered in a correct sequence that the payloads stored to the buffers are intended for delivery within the stream. In an example, the read loop provides a read loop method, and the read loop method is called on the read loop (e.g., the runtime object that is the read loop). In response, the read loop of this example begins to consume the buffers presented in the queue of buffers maintained by the stream reader. In this example, while the read loop method is executing, the read loop obtains a buffer from the queue of buffers as a result of the read loop invoking a poll method on the stream reader. Upon obtaining a buffer from the queue of buffers in this example, the read loop passes the buffer to the frames decoder by calling a submit method on the frames decoder while specifying the buffer as a parameter of the request.

In an embodiment, the frames decoder receives buffers transmitted from the read loop, and the frames decoder adds the buffers to a buffers reader (Operation 610). The buffers reader is a list buffers reader that is capable of wrapping multiple buffers. Recall that, depending on the protocols that governed the transmission of the incoming frames to the system, the outgoing frames may have been indiscriminately split and segmented before being encoded into the incoming frames. While the frames decoder will receive the buffers in an order that corresponds to the correct sequence of stream data within the stream, generating an outgoing frame by way of interacting with individual buffers may nonetheless be a non-trivial task to the extent that the outgoing frame is arbitrarily divided amongst multiple buffers. To avoid the computational complexity that would be incurred while attempting to reconstruct an outgoing frame that has been dispersed across multiple buffers, the frames decoder relies on the buffers reader to serve as an abstraction of the multiple buffers. The buffers reader maintains a list of abstracted buffers, and the buffers reader presents a continuous sequence of elements. If a buffer is entered into the list of abstracted elements, elements represented by that buffer may be included in the continuous sequence of elements that is presented by the buffers reader. In an example, the buffers reader provides an add method, and the frames decoder transmits a buffer to the buffers reader by calling the add method on the buffers reader while specifying the buffer as a parameter of the request.

In an embodiment, the frames decoder extracts outgoing frames from the payloads of the incoming frames that are aggregated by the buffers reader, and the frames decoder transmits the outgoing frames to the read loop (Operation 612). In an example, the frames decoder decodes stream data encoded into the continuous sequence of elements presented by the buffers reader by calling a decode method of an outgoing frame reference type while specifying the buffers reader as a parameter of the request. In this example, the decode method is a static method of an outgoing frame reference type. By presenting the elements represented by the individual buffers as a continuous sequence of elements, the buffers reader allows the decode method of this example to read stream data that is split across multiple buffers as if the stream data were instead represented by a single buffer. Typically, in this example, the decode method returns an outgoing frame that is decoded from the continuous sequence of elements, or the static decode method returns null. If the static decode method returns an outgoing frame in this example, the outgoing frame is (a) a complete frame, (b) a partial frame, (c) an unknown partial frame, (d) a malformed frame, or (e) another variety of an outgoing frame.

In an embodiment, the read loop delivers the outgoing frames to a stream recipient (Operation 614). An outgoing frame delivered to the stream recipient is a complete frame, a partial frame, a malformed frame, or another variety of outgoing frame. Returning a partial frame to the stream recipient rather than a complete frame may allow the read loop to begin delivery of the partial frame's payload to the stream recipient prior to the entirety of the partial frame being decoded. The ability to begin delivery of a frame's payload prior to the entirety of that payload being decoded may reduce the amount of buffer memory that is consumed by the system and reduce the overall latency of stream data delivery. An outgoing frame may be delivered to a stream recipient as a runtime object related to an outgoing frame reference type, as stream data formatted according to a protocol associated with that outgoing frame, and/or in any another medium.

### 5. MANAGING RESOURCES

FIG. 7 illustrates an example set of operations for managing resources available for parsing stream data in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments. In an embodiment, techniques described in this Section 5 are applied to protocol frames; to provide clear examples, the remainder of the discussion in this Section 5 assumes the same. However, the techniques described herein are not limited to protocol frames. The techniques described in this Section 5 are equally applicable to other units of stream data and other information.

In an embodiment, the system receives an incoming frame of a stream that is established over a network connection, and the system stores at least part of the incoming frame in memory (Operation 702). While in route to the system, one or more protocols dictate the format of the incoming frame. In general, the formatting of the incoming frame may vary depending on the protocols in play. However, the incoming frame often includes a header that specifies frame metadata that can be used to process the incoming frame (e.g., a frame type, a stream ID, a frame offset, a frame length, etc.). Depending on the frame type of the incoming frame, the incoming frame may also include a payload. In some cases, the incoming frame is delivered to the system packaged in other unit(s) of stream data. As an example, assume that the incoming frame is a QUIC frame. In this example, the incoming frame may be delivered to the system packaged within a QUIC packet, and the QUIC packet may, in turn, be delivered to the system packaged with a UDP packet.

The system, according to an embodiment, stores at least part of the incoming frame in runtime memory. For example, an incoming frame may be manifested in runtime memory as an instance of an incoming frames class. Depending on the characteristics of the incoming frame, the system may also generate other abstractions to represent other aspects of the incoming frame in runtime memory. For example, if the incoming frame delivers a payload, the incoming frame may be accompanied in runtime memory by a buffer that represents the incoming frame's payload. The buffer may, in turn, be backed by an underlying data structure that stores the data included in the incoming frame's payload. Thus, in this example, the incoming frame is described in memory space that is allocated to three separate runtime objects. One runtime object representing one aspect of the incoming frame may be allocated a different section of memory than another runtime object that represents another aspect of the incoming frame. The payload of any given frame may be the largest part of that frame. Accordingly, if the incoming frame delivers a payload to the system, it may be that a large majority of the memory space that describes the incoming frame is allocated to an underlying data structure that backs a buffer representing the payload. Furthermore, in this scenario, the underlying data structure that stores the incoming frame's payload may have originally been allocated for storing data delivered by a larger unit of stream data (e.g., a packet) that included the incoming frame. Therefore, the underlying data structure that stores the incoming frame's payload may reserve more memory space than is necessary even if no part of the incoming frame's payload is extraneous.

In an embodiment, the system determines if any of the information delivered by the incoming frame requires further processing, and the system proceeds to another operation based on the determination (Operation 704). In other words, the system is determining if the incoming frame has delivered any relevant data. If the system determines that at least some of the information delivered by the incoming frame requires further processing (YES at Operation 704), the system proceeds to Operation 706. Alternatively, if the system determines that the incoming frame has delivered no information that requires further processing (NO at Operation 704), the system discards the incoming frame and proceeds to Operation 710. In this alternative scenario, the incoming frame is fully extraneous. How the incoming frame is discarded by the system may vary depending on the application. In an example, the system includes a garbage collection process, and the system discards the incoming frame by rendering memory space that describes the incoming frame eligible for reclamation by the garbage collection process.

The system, according to an embodiment, determines if the incoming frame requires further processing based, at least in part, on a frame type of the incoming frame. In some cases, the frame type may even serve as a definitive indicator of whether or not the incoming frame requires further processing. As an example, assume that the incoming frame is a QUIC frame. Specifically, the incoming frame is a QUIC padding frame in this example. A QUIC padding frame has no semantic value. Generally, the purpose of a QUIC padding frame is to increase the size of a QUIC packet that includes the QUIC padding frame without conveying any additional content. Therefore, in this example, the system concludes that the incoming frame can be entirely discarded. In other cases, the system cannot determine whether or not the incoming frame requires further processing based on the frame type. As another example, assume that the incoming frame is a QUIC stream frame or a QUIC crypto frame. The QUIC stream frames and QUIC crypto frames generally deliver payloads. To determine if the incoming frame requires further processing in this other example, the system may need to evaluate other frame metadata of the incoming frame, attributes of the stream that include the incoming frame, frame metadata of other frames belonging to the same stream, and/or other information.

If the incoming frame delivers a payload, the system, according to an embodiment, may conclude that the incoming frame can be discarded if the entirety of incoming frame's payload (a) has previously been delivered to the system and/or (b) is otherwise extraneous. For example, the system may conclude that the incoming frame can be discarded if (a) the incoming frame is a duplicate of another frame and/or (b) the incoming frame is fully overlapped by other frame(s). On the other hand, the system may conclude that at least some part of the incoming frame should be retained in memory for further processing if the incoming frame's payload includes at least some relevant stream data that has not previously been delivered to the system.

If the incoming frame delivers a payload of stream data, the system, according to an embodiment, determines if any part of the incoming frame requires further processing based, at least in part, on a comparison between (a) a frame offset of the incoming frame and (b) a flow offset of the stream that includes the incoming frame. The flow offset is maintained by a stream organizer that is responsible for administering the stream that includes the incoming frame, and the flow offset measures the stream data of that stream that has been released by the stream organizer for further processing thus far. Based on the comparison between the frame offset of the incoming frame and the flow offset of the stream, the system may determine if the incoming frame has arrived early, on time, or late. If the frame offset of the incoming frame is greater than the flow offset, the incoming frame has arrived early. If the frame offset of the incoming frame matches the flow offset, the incoming frame has arrived on time. If the frame offset of the incoming frame is less than the flow offset, the incoming frame has arrived late.

If the incoming frame has arrived early, the system, according to an embodiment, compares the incoming frame to any other frames that are listed in an ordered queue of frames that is maintained by a stream organizer. Any frames included in the ordered queue of frames are frames that cannot yet be released by the stream organizer for further processing. The system may compare frame metadata of the incoming frame with frame metadata of any frames that are included in the ordered queue. Based on these comparison(s), the system typically concludes that at least part of the incoming frame should be retained in memory if (a) the incoming frame does not overlap with any other frames in the ordered queue or (b) the incoming frame is partially overlapped by other frame(s) in the ordered queue. On the other hand, the system typically concludes that the entirety of the incoming frame can promptly be discarded if the incoming frame is (a) fully overlapped by other frame(s) in the ordered queue and/or (b) a duplicate of another frame in the ordered queue.

If the incoming frame has arrived on time, the system, according to an embodiment, generally concludes that at least part of the incoming frame's payload should be retained in memory for further processing. In this scenario, the system can typically assume that at least a leading part of the incoming frame's payload has not yet been delivered by any other frame.

If the incoming frame has arrived late, the system, according to an embodiment, compares the endpoint of the incoming frame to the flow offset of the stream that includes the incoming frame. The system can determine the endpoint of the incoming frame based on (a) the frame offset of the incoming frame and (b) the frame length of the incoming frame. If the endpoint of the incoming frame is less than the flow offset, the incoming frame's payload does not include any relevant data that has not previously been delivered to the system. Therefore, the system generally discards the incoming frame entirely if the endpoint of the incoming frame is less than the flow offset. On the other hand, if the endpoint of the incoming frame is greater than the flow offset, the system generally concludes that at least part of the incoming frame should be retained in memory for further processing.

In an embodiment, the system determines if the incoming frame should be replaced by a new frame, and the system proceeds to another operation based on the determination (Operation 706). In general, if not all of the incoming frame needs to be processed, the system may choose to replace the incoming frame with a new frame. For example, if one part of the incoming frame is relevant data that warrants further processing, and another part of the incoming frame is extraneous data that does not warrant further processing, the system may choose to replace the incoming frame with a new frame that (a) includes the one part of the incoming frame and (b) excludes the other part of the incoming frame. If the system concludes that the incoming frame should be replaced by a new frame (YES at Operation 706), the system proceeds to Operation 712. Alternatively, if the system concludes that the incoming frame should not be replaced by a new frame (NO at Operation 706), the system proceeds to Operation 708.

The system, according to an embodiment, chooses to replace the incoming frame if (a) the incoming frame is delivered early and (b) the incoming frame is partially overlapped by other frame(s) listed in an ordered queue of frames maintained by a stream organizer. In this scenario, the system may choose to replace the incoming frame with a new frame that excludes any overlapping parts of the incoming frame. In an example, a leading part of the incoming frame (i.e., a leading part of the incoming frame's payload) overlaps with a trailing part of another frame (i.e., a trailing part of the other frame's payload) in the ordered queue, and the system chooses to replace the incoming frame with a new frame that (a) excludes the leading part of the incoming frame and (b) includes a trailing part of the incoming frame. In another example, a trailing part of the incoming frame overlaps with a leading part of another frame in the ordered queue, and the system decides to replace the incoming frame with a new frame that excludes the trailing part of the incoming frame. In yet another example, a leading part of the incoming frame is overlapped by one frame in the ordered queue, and a trailing part of the incoming frame is overlapped by another frame in the ordered queue. Accordingly, the system of this other example chooses to replace the incoming frame with a new frame that includes a middle part of the incoming frame.

The system, according to an embodiment, concludes that the incoming frame does not need to be replaced if (a) the incoming frame arrives early and (b) the incoming frame does not overlap with any frame in the ordered queue of frames maintained by a stream organizer.

The system, according to an embodiment, concludes that the incoming frame does not need to be replaced if (a) the incoming frame arrives early and (b) the incoming frame fully overlaps other frame(s) that are listed in an ordered queue of frames maintained by a stream organizer. As an example, assume that (a) the incoming frame fully overlaps another frame in the ordered queue, and (b) the incoming frame does not overlap with any other frame in the ordered queue. In this example, the incoming frame includes at least some data that is not included within the other frame that is fully overlapped by the incoming frame. In other words, the incoming frame of this example includes some relevant data that has not been delivered by the other frames. Accordingly, the system determines to retain the incoming frame in its entirety. The system of this example then concludes that the other fully overlapped frame can now be discarded. In this example scenario, the system is choosing to retain the entirety of the incoming frame despite that fact that part of the incoming frame has previously been delivered to the system.

The system, according to an embodiment, concludes that the incoming frame does not need to be replaced if the incoming frame arrives on time. If a trailing part of the incoming frame overlaps with a leading part of another incoming frame in the ordered queue of frames maintained by the stream organizer, the system may replace the other frame with a truncated version of the other frame. In this example scenario, the system is choosing to retain the entirety of the incoming frame even though part of the incoming frame has previously been delivered to the system. In an alternative embodiment, the system may replace the incoming frame with a new frame that excludes the trailing part of the incoming frame that overlaps with the other frame in the ordered queue in this example scenario.

The system, according to an embodiment, concludes that the incoming frame should be replaced if the incoming frame arrives late. The incoming frame arriving late typically implies that at least a leading part of the incoming frame has already been delivered to the system and released by the stream organizer for further processing. Therefore, the system concludes that the incoming frame should be replaced by a new frame that will exclude at least a leading part of the incoming frame.

If the incoming frame partially overlaps with another previously delivered frame, the system, according to an embodiment, either (a) eliminates the overlap by replacing the incoming frame or (b) eliminates the overlap by replacing the other frame. If the other frame has already been released by a stream organizer for further processing, the system will typically replace the incoming frame rather than the other frame. However, if the other frame has not yet been released by a stream organizer for further processing, the system may perform a cost benefit analysis to select an appropriate frame to replace. For instance, the system may compare (a) the estimated cost and/or advantage of replacing the incoming frame and (b) the estimated cost and/or advantage of replacing the other frame. As an example, assume that replacing the incoming frame would require partitioning the incoming frame, and further assume that replacing the other frame would require partitioning the other frame. Thus, in this example, no matter what frame is replaced by the system, the system will need to copy a part of a frame to another location in memory. While the cost of copying any given dataset may depend on a variety of factors (e.g., register sizes, computer architecture, memory bandwidth, etc.), relocating less data is often computationally cheaper than relocating more data. Accordingly, the system in this example may conclude that the incoming frame should be replaced if the non-overlapping part of the incoming frame is smaller than the non-overlapping part of the other frame. Alternatively, the system of this example may conclude that the incoming frame should not be replaced if the non-overlapping part of the incoming frame is bigger than the non-overlapping part of the other frame. In this alternative scenario, the system of this example replaces the other frame instead.

If an underlying data structure storing relevant data delivered by the incoming frame occupies excess memory space, the system, according to an embodiment, may conclude that the incoming frame should be replaced. As discussed above, the term “excess memory space” refers to memory space occupied by an underlying data structure that is not needed to store relevant data delivered by a particular incoming frame. It should be noted that an underlying data structure storing relevant data delivered by the incoming frame may occupy excess memory space even if no part of the incoming frame is extraneous. Therefore, in some cases, the system may conclude that the incoming frame should be replaced even if no part of the incoming frame is extraneous. For example, if an underlying data structure storing the incoming frame's payload occupies excess memory space, the system may conclude that the incoming frame should be replaced even if the incoming frame does not overlap with another frame. It should also be noted that excess memory space does not necessarily store extraneous data. Excess memory space may store (a) extraneous data, (b) relevant data, and/or (c) no data. As an example assume that the incoming frame is transmitted to the system packaged within a packet. In this example, an underlying data structure storing relevant data delivered by the incoming frame was originally allocated for storing the data that was delivered by the packet. In addition to the incoming frame, the packet of this example delivered other data. As a result, the underlying data structure storing the relevant data delivered by the incoming frame occupies excess memory space that was allocated for the other data included in the packet of this example. In this example, the other data stored to the excess memory space may include extraneous data (e.g., padding, an overlapping frame, a duplicate frame etc.), and/or the data stored to the excess memory space may include relevant data (e.g., another frame that is non-overlapping).

If an underlying data structure storing the incoming frame occupies excess memory space, the system, according to an embodiment, may determine whether or not the incoming frame should be replaced based on (a) the amount of relevant data delivered by the incoming frame, (b) the amount of excess memory space that is occupied by the underlying data structure, (c) the total amount of memory space occupied by the underlying data structure, and/or (d) other factors. In an example, the system compares the amount of relevant data delivered by the incoming frame to the total amount of memory space occupied by the underlying data structure. If the amount of relevant data corresponds to a relatively larger proportion of the total memory space occupied by the underlying data structure in this example, the system may conclude that the incoming frame need not be replaced. Alternatively, if the amount of relevant data corresponds to a relatively smaller proportion of the total memory space occupied by the underlying data structure in this example, the system may conclude that the incoming frame should be replaced (e.g., by partitioning the incoming frame). If the total amount of memory space occupied by the underlying data structure is unknown in this example, the system may assume that the total amount of memory space occupied by the underlying data structure is equal to the total size of the incoming frame's payload. Additionally, or alternatively, if the total amount of memory space occupied by the underlying data structure is unknown in this example, the system may preemptively decide to partition the incoming frame without performing any comparison of relative sizes. In this example, partitioning the incoming frame generally causes at least one chain of strong references leading to the underlying data structure to be broken. If all chains of strong reference(s) leading to the underlying data structure are broken in this example, the memory space occupied by the underlying data structure may be reclaimed. Note that, in this example, if the system partitions the incoming frame, the system may have to partition or discard any other relevant frames stored to the underlying data structure prior to reclaiming the memory space occupied by the underlying data structure. The system may or may not partition another relevant frame stored to the same underlying data structure in this example. Even if another relevant frame stored to the same underlying data structure is not partitioned in this example, partitioning the incoming frame may nonetheless allow excess memory space to be reclaimed sooner if the incoming frame is retained in buffer memory longer than the other frame.

In an embodiment, the system processes the incoming frame (Operation 708). How the incoming frame is processed by the system may vary depending on the circumstances. Example factors that may influence how the incoming frame is processed include the frame type of the incoming frame, the content of the incoming frame, and others. For instance, an authentication frame (e.g., a QUIC crypto frame) may be processed differently than a frame that delivers stream data intended for a stream recipient (e.g., a QUIC stream frame). Additional embodiments and/or examples relating to processing the incoming frame are described above in Section 4 titled “Parsing Stream Data.” Once the incoming frame has been completely processed, the system discards the incoming frame.

In an embodiment, the system reclaims memory occupied by the incoming frame (Operation 710). Memory occupied by the incoming frame is reclaimed by a garbage collection process of the system. Additionally, or alternatively, memory occupied by the incoming frame is manually deallocated by a program instance. Some programming languages allow a program instance to manually deallocate memory space, whereas other programming languages do not allow a program instance to manually deallocate memory space. In an example, the incoming frame is represented in runtime memory by runtime object(s), and the system reclaims memory occupied by the incoming frame by reclaiming memory space that describes those runtime object(s).

The system, according to an embodiment, is configured to selectively expedite the reclamation of memory space occupied by the incoming frame. For example, the system may expedite the reclamation of memory space describing the incoming frame (a) if memory pressure is high, (b) if the incoming frame is allocated a large amount of memory space, (c) if indications of potentially malicious activity are detected, and/or (d) for other reasons. How the system expedites the reclamation of memory space may vary. In an example, reclamation of memory space allocated for the incoming frame is hastened by a garbage collection process. In another example, reclamation of memory space allocated for the incoming frame is expedited by a program instance that is configured to parse incoming frames (e.g., a method of a stream organizer or another component of the system). A program instance may accelerate reclamation of memory space allocated for the incoming frame by (a) manually deallocating that memory space, (b) requesting deallocation by the garbage collection process, (c) breaking any remaining references to representations of the incoming frame, and/or (d) performing other cleanup operations.

In an embodiment, the system determines if the new frame should be created by slicing the incoming frame, and the system proceeds to another operation based on the determination (Operation 712). To decide whether or not the incoming frame should be sliced, the system may perform a cost benefit analysis between (a) slicing the incoming frame and (b) partitioning the incoming frame. Recall that slicing a frame is often computationally cheaper than partitioning the frame. However, if the new frame is created by slicing the incoming frame, the system may be delayed from reclaiming memory space describing extraneous data delivered by the incoming frame. In particular, the system may be delayed from regaining memory space occupied by the extraneous data until after the system has finished processing the relevant data delivered by the incoming frame (i.e., the new frame). On the other hand, if the new frame is created by partitioning the incoming frame, the system is generally enabled to reclaim memory space that is occupied by the extraneous data delivered by the incoming frame shortly after the new frame is created. If the system determines that the new frame should be created by slicing the incoming frame (YES at Operation 712), the system proceeds to Operation 714. Alternatively, if the system determines that the new frame should be created by partitioning the incoming frame (NO at Operation 712), the system proceeds to Operation 716.

The system, according to an embodiment, determines how the new frame should be created by applying a rule set to (a) the characteristics of the incoming frame (e.g., fame metadata), (b) characteristics of other units of stream data in the same stream and/or other stream(s) parsed by the system, (c) stream attributes, (d) operating conditions of the system, (e) characteristics of an underlying data structure that stores the incoming frame's payload, and/or (d) other information. The rule set may include one or more thresholds that distinguish frames that should be sliced from frames that should be partitioned. The threshold(s) are predetermined threshold(s), or the threshold(s) are formulated by the system to suit the circumstances of the present application. Once determined, the threshold(s) applied by the system are constant, and the system adjusts the threshold(s) dynamically to reflect changing conditions.

The system, according to an embodiment, compares the amount of extraneous data delivered by the incoming frame to a threshold amount of data. The threshold amount of data is the amount of data that the system concludes is worth reclaiming early at the expense of the computational savings that would otherwise be attained by slicing the frame. For example, assume that the threshold amount of data is 128 bytes. If the amount of memory space occupied by the extraneous data is less than 128 bytes in this example, the system decides to create the new frame by slicing the incoming frame. Alternatively, if the amount of memory space occupied by the extraneous data is equal to or greater than 128 bytes in this example, the system elects to create the new frame by partitioning the incoming frame.

The system, according to an embodiment, calculates ratio(s) between (a) the amount of relevant data delivered by the extraneous frame, (b) the amount of extraneous data delivered by the incoming frame, (c) the total amount of data delivered by the incoming frame, (d) the size of an underlying data structure that stores the relevant data delivered by the incoming frame, and/or (e) another value. It should be noted that, in this scenario, the incoming frame may not have delivered any extraneous data. In an example, the system may calculate a ratio by dividing the frame length of the incoming frame by the frame length of the new frame, and the system may compare the calculated ratio to a threshold ratio. For the purposes of this example, assume that 1.25 is the threshold ratio. If the calculated ratio (i.e., the frame length of the incoming frame divided by the frame length of the new frame) is equal to or greater than 1.25, the system decides to partition the incoming frame in this example. Stated differently, if 20% or more of the incoming frame is extraneous data, the system decides to partition the incoming frame in this example. On the other hand, if less than 20% of the data delivered by the incoming frame is extraneous (i.e., the calculated ratio is less than 1.25), the system of this example decides to slice the incoming frame. In another example, the system calculates a ratio between (a) the amount of relevant data delivered by the incoming frame and (b) the size of an underlying data structure that stores the relevant data, and the system compares that ratio to a threshold ratio. If the amount of relevant data is sufficiently low relative to the capacity of the underlying data structure, the system of this example decides to partition the incoming frame.

The system, according to an embodiment, determines how to create the new frame based, at least in part, on the timing of the incoming frame's arrival. For example, if the incoming frame arrives on time or late, the system may favor slicing the incoming frame. If the incoming frame arrives on time or late, the system can generally assume that the new frame will be promptly released by a stream organizer for further processing (i.e., the new frame will not be held in the ordered queue of ordered frames) and therefore might be fully processed faster than another frame that is held in the ordered queue of frame. On the other hand, if the incoming frame arrives early in this example, the system may favor partitioning the incoming frame because it may take longer for the new frame to be processed. In this example, the system may favor partitioning the incoming frame to a degree corresponding to how early the incoming frame has arrived. The system may gauge how early the incoming frame has arrived based on a differential between a frame offset (e.g., of the incoming frame or the new frame) and a flow offset of the stream that includes the incoming frame.

The system, according to an embodiment, decides how to create the new frame based, at least in part, on a prediction of how much time will elapse before the new frame is fully processed and/or the memory reserved by the new frame can be reclaimed. In an example, the system decides to partition the incoming frame because the predicted amount of time that will elapse before the new frame is fully processed exceeds a threshold amount of time.

The system, according to an embodiment, determines how the new frame should be created based, at least in part, on an estimation of how likely it is that a region of memory storing some part of the incoming frame will be subjected to garbage collection in the near future. As an example, consider a region of memory that stores the extraneous part of the incoming frame. In general, if the system deems it likely that this region of memory will be subjected to garbage collection in the near future, the system of this example may favor partitioning the new frame rather than slicing the new frame. On the other hand, if the system of this example currently assesses this region of memory to be a poor candidate for garbage collection, the system of may favor slicing the incoming frame. In this example, the system may estimate the likelihood of collection in the region of memory storing the extraneous information based on a liveness ratio for runtime objects residing in that region of memory relative to the liveness ratios of other regions of memory. Recall that a live object may be considered ineligible for garbage collection. Therefore, a garbage collection process of this example may prioritize reclaiming memory space in a region of memory characterized by a lower liveness ratio over another region of memory that is characterized by a higher liveness ratio.

The system, according to an embodiment, determines how the new frame should be created based, at least in part, on the operating conditions of memory resources that are available for parsing stream data. In an example, the system decides to partition the incoming frame because the amount of data available for storing stream data is below a threshold capacity. In another example, the system decides to partition the incoming frame because memory pressure on memory resources available for storing stream data is above a threshold ratio (e.g., a threshold percentage of capacity).

The system, according to an embodiment, determines how the new frame should be created based on indications of potentially malicious activity or the lack thereof. For instance, the system may monitor stream data for indications of an attempt to overwhelm the system's memory resources by inducing the system to buffer large amounts of extraneous information for extended amounts of time. In an example, the system decides to partition the incoming frame because a threshold indication of potentially malicious activity is detected. Example conditions that may suggest the presence of malicious activity include the following: (a) an abnormal amount of extraneous data being delivered to the system (e.g., padding, overlapping data, etc.), (b) an unusual amount of stream data arriving out of order, (c) a source of stream data having yet to be authenticated (e.g., the incoming frame is a crypto frame), and (d) others.

The system, according to an embodiment, determines how to create the new frame based, at least in part, on one or more of multiple thresholds. In an example, the system may compare a threshold amount of data to the quantity of extraneous data delivered by the incoming frame, and the system may compare a threshold ratio to a ratio that characterizes the amount of extraneous data delivered by the incoming frame. If the system applies multiple thresholds, the system may require the incoming frame to satisfy one threshold to qualify for partitioning, or the system may require the incoming frame to satisfy multiple thresholds to qualify for partitioning. Additionally, or alternatively, the system may apply one threshold if one condition exists, and the system may apply another threshold if another condition exists. For example, if memory pressure is low, the system may apply one threshold, but if memory pressure is high, the system may alternatively apply another threshold.

The system, according to an embodiment, alters threshold(s) to compensate for changing circumstances. As an example, assume that the system will partition the incoming frame if the amount of extraneous data delivered by the incoming frame matches or surpasses a threshold amount of data. In this example, the system decreases the threshold amount of data if the memory pressure is rising, and the system increases the threshold amount of data if memory pressure is decreasing. In another example, the system adjusts a threshold so that fewer frames will be sliced, and more frames will be partitioned if the number of streams being parsed by the system increases. In yet another example, the system adjusts a threshold so that fewer frames will be sliced, and more frames will be partitioned if the system detects signs of malice from a source of stream data.

The system, according to an embodiment, generates threshold(s) that are tailored to the resources that are available for parsing stream data in the present application. In an example, the system tailors thresholds so that fewer frames are partitioned if the system gauges that memory resources are abundant in the present application. Alternatively, if the system gauges that memory resources are relatively scarce in the present application, the system of this example tailors threshold(s) so that more frames are partitioned. In another example, the system tailors threshold(s) so that fewer frames are partitioned if the system concludes that processing resources to be relatively scant for the present application. To generate threshold(s), the system may apply one or more trained machine learning models to the circumstances of the present application. The machine learning model(s) are trained using historical data collected from previous applications of the system and/or other training data.

In an embodiment, the system creates the new frame by slicing the incoming frame (Operation 714). The new frame includes relevant data delivered by the incoming frame, and the new frame excludes extraneous data delivered by the incoming frame. In this scenario, at least part of the new frame will be a shared subsequence of at least part of the incoming frame. In other words, the new frame and the incoming frame are both, at least partially, described by the same section of memory in this scenario. For example, if the incoming frame delivers a payload of stream data that is partially extraneous, the system generates a new frame and a new payload. In this example, the new payload is a shared subsequence of the incoming frame's payload. By slicing the incoming frame, the system is effectively reallocating a section of memory to the new frame that was previously allocated to the incoming frame without changing the dimensions of that section of memory. Creating the new frame in this manner typically prevents the system from having to copy relevant data to another section of memory. However, the system may be prevented from reclaiming memory space that is occupied by the extraneous part of the incoming frame until after the system has finished processing the new frame.

In an embodiment, the system creates the new frame by partitioning the incoming frame (Operation 716). The new frame includes relevant data delivered by the incoming frame, and the new frame excludes any extraneous data delivered by the incoming frame. In this scenario, it may be that the incoming frame did not deliver any extraneous data. The system may copy the relevant data to another section of memory while partitioning the incoming frame. Accordingly, the system may subsequently be allowed to reclaim excess memory space. As an example, assume the incoming frame delivers a partially extraneous payload that is stored in a particular section of memory. In this example, the system creates a new frame and a new payload. The system of this example creates the new payload by copying the relevant data from the particular section of memory and storing the relevant data in another section of memory. While this copying operation may incur added computational cost, it generally enables the system of this example to reclaim the section of memory shortly after the new frame is created.

In an embodiment, the system reclaims memory occupied by the incoming frame (Operation 718). Recall that in this scenario, the system created the new frame by partitioning the incoming frame. No part of the new frame is a shared subsequence of the incoming frame in this scenario. Therefore, the system may reclaim the entirety of the memory space that was originally allocated for the new frame. Memory occupied by the incoming frame is reclaimed by a garbage collection process of the system. Additionally, or alternatively, memory occupied by the incoming frame is manually deallocated by a program instance. As an example, assume that the incoming frame delivered a payload of partially extraneous stream data, and further assume that the incoming frame is stored in runtime memory. In this example, the incoming frame is accompanied in runtime memory by a buffer that represents the payload, and the buffer is backed by an underlying data structure that stores the partially extraneous stream data. In this example, a garbage collection process reclaims memory space allocated to (a) the incoming frame, (b) the buffer, and (c) the underlying data structure.

In an embodiment, the system processes the new frame (Operation 720). How the new frame is processed by the system may vary depending on the circumstances. Example factors that may influence how the new frame is processed include the frame type of the incoming frame, the content of the incoming frame, and others. Additional embodiments and/or examples relating to processing the new frame are described above in Section 4 titled “Parsing Stream Data.” Once the new frame has been completely processed, the system discards the new frame.

In an embodiment, the system reclaims memory space allocated for the new frame (Operation 722). Memory allocated to the new frame is reclaimed by a garbage collection process of the system. Additionally, or alternatively, memory allocated to the new frame is manually deallocated by a program instance. Depending on how the new frame was created, the system may be reclaiming memory space that was originally allocated for storing the incoming frame. Specifically, the system is reclaiming memory space that was originally allocated for the incoming frame if the new frame was created by slicing the incoming frame. In this scenario, the system is regaining memory space that is occupied by both (a) the relevant data delivered by the incoming frame and (b) the extraneous data delivered by the incoming frame. Alternatively, if the new frame was created by partitioning the incoming frame, the system is now regaining memory space that is occupied by the relevant data delivered by the incoming frame. In this alternative scenario, the system may have previously regained the memory space that was occupied by the extraneous data delivered by the incoming frame.

### 6. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

### 6.1 Example Packet Architecture

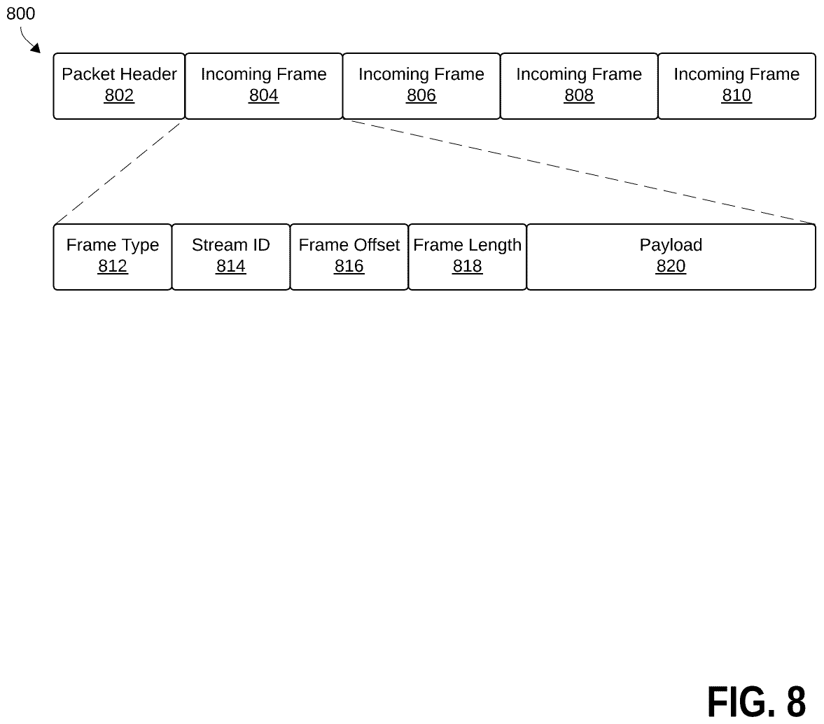

FIG. 8 illustrates a packet 800 that is transmitted to the system through a network connection in accordance with an example embodiment. As illustrated in FIG. 8, packet 800 includes packet header 802, incoming frame 804, incoming frame 806, incoming frame 808, and incoming frame 810. A packet may include more or fewer components than packet 800 as illustrated in FIG. 8.

In an example embodiment, packet 800 is delivered to the system embedded in other unit(s) of stream data. For the purposes of the example illustrated by FIG. 8, assume that packet 800 is transmitted to the system in accordance with the QUIC protocol. Recall that the QUIC protocol is built on top of UDP. In this example, packet 800 is delivered to the system in a single UDP datagram (i.e., a UDP packet), or packet 800 is delivered to the system in multiple UDP datagrams. In this example, packet 800 may be delivered to the system in an incorrect sequence relative to other packets of the same stream. Furthermore, in this example, one part of packet 800 embedded into one UDP datagram may be delivered to the system in an incorrect sequence relative to another part of packet 800 embedded into another UDP datagram.

In an example embodiment, packet 800 includes packet header 802, and packet 800 embeds multiple incoming frames. Packet 800 delivers incoming frames of a single stream, or packet 800 delivers incoming frames of multiple streams. Stream data describing an incoming frame included in packet 800 may be split across one or more other packets.

In an example embodiment, packet header 802 specifies packet metadata that is used to route packet 800 to the system. Example packet metadata that may be specified within packet header 802 includes a header type, a fixed bit, a spin bit, reserved bits, a key phase, a packet number length, a destination connection ID, and/or other information.

In an example embodiment, incoming frame 804 is a protocol frame carrying stream data. In the example illustrated by FIG. 8, incoming frame 804 is formatted according to a QUIC protocol. Specifically, incoming frame 804 is formatted according a stream frame format defined by the QUIC protocol. Accordingly, incoming frame 804 includes a frame type 812, a stream ID 814, a frame offset 816, a frame length 818, and a payload 820. An incoming frame may include more or fewer components than the components of incoming frame 804 as illustrated in FIG. 8. For instance, if incoming frame 804 is a different frame type than incoming frame 806, incoming frame 804 may include more or fewer components than incoming frame 806.

In an example embodiment, frame type 812 is binary data that indicates attributes of incoming frame 804. In the example illustrated by FIG. 8, frame type 812 indicates (a) incoming frame 804 is a QUIC stream frame, (b) incoming frame 804 includes an offset field (i.e., frame offset 816), (c) incoming frame 804 includes a length field (i.e., frame length 818), and (d) incoming frame 804 is not the final frame of a stream.

In an example embodiment, stream ID 814 is binary data that specifies the identify of a stream that incoming frame 804 belongs to. Recall that packet 800 may carry incoming frames corresponding to multiple streams. Accordingly, stream ID 814 may identify a different stream than the stream ID specified in the header of another incoming frame included within packet 800. For instance, incoming frame 804 corresponds to the same stream as incoming frame 806, or incoming frame 804 corresponds to a different stream than incoming frame 806.

In an example embodiment, frame offset 816 is binary data indicating the position of payload 820 within the stream that is identified by stream ID 814. In particular, frame offset 816 indicates a starting position of payload 820. In the example illustrated by FIG. 8, frame offset 816 is a byte offset. In other words, frame offset 816 specifies the address of a byte in this example.

In an example embodiment, frame length 818 is binary data indicating the size of payload 820. In the example illustrated by FIG. 8, frame length 818 specifies a number of bytes occupied by payload 820.

In an example embodiment, payload 820 is binary stream data of the stream that is identified by stream ID 814. Payload 820 encodes at least part of an outgoing frame. In the example illustrated by FIG. 8, an outgoing frame encoded to payload 820 may be an HTTP/3 frame. Payload 820 may encode a part of an HTTP/3 frame, an entire HTTP/3 frame, and/or multiple HTTP/3 frames. If payload 820 encodes one part of an HTTP/3 frame, another part of the HTTP/3 frame is embedded in another incoming frame within packet 800, and/or another part of the HTTP/3 frame is embedded in an incoming frame within another packet.

### 6.2 Example Frame Replacement

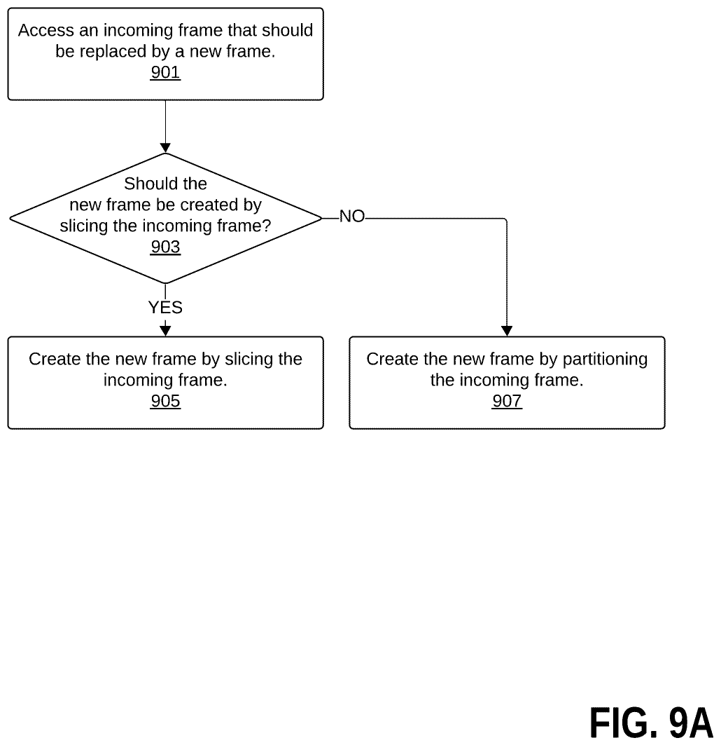

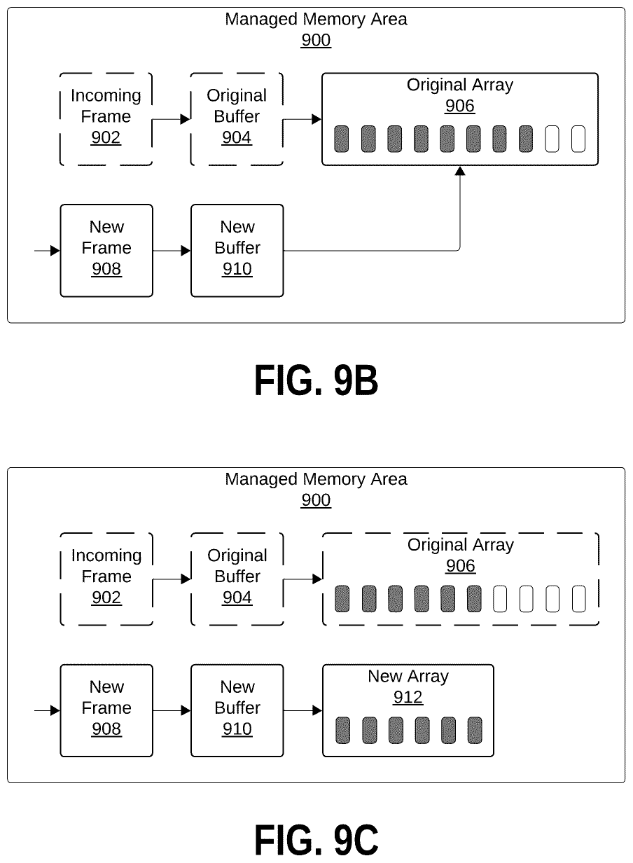

FIG. 9A illustrates an example set of operations for generating a new frame to replace an incoming frame in accordance with an example embodiment. Potential outcomes of performing the operations illustrated in FIG. 9A are described below with respect to FIGS. 9B and 9C. The system may perform operation(s) illustrated in FIG. 9A pursuant to a request by a program instance to execute a method that is offered by a component of the system. For example, instructions for completing operation(s) illustrated in FIG. 9A may be defined in a method provided by a stream organizer of the system. One or more operations illustrated in FIG. 9A may be modified, rearranged, or omitted. Accordingly, the particular sequence of operations illustrated in FIG. 9A should not be construed as limiting the scope of one or more embodiments.

In an example embodiment, the system accesses an incoming frame 902 residing in managed memory that warrants replacement (Operation 901). The incoming frame delivered a payload of stream data to the system, and the incoming frame is accompanied in the managed memory area by a buffer (hereafter the “original buffer”) 904 that represents the incoming frame's 902 payload. The original buffer 904 is, in turn, backed by an array (hereafter the “original array”) 906 that stores the stream data delivered by the incoming frame's 902 payload. The system concludes that the incoming frame 902 should be replaced by a new frame 908 because (a) the incoming frame's 902 payload is partially extraneous and/or (b) the original array 906 stores other data that is extraneous. It should be noted that if the original array 906 stores other data that is extraneous, the system may elect to replace the incoming frame 902 even if no part of the incoming frame's 902 payload is extraneous.

In an example embodiment, the system determines if the new frame 908 should be created by slicing the incoming frame 902, and the system proceeds to another operation based on the determination (Operation 903). More specifically, the system determines if the new frame 908 should be created by slicing original buffer 904. In the example illustrated by FIG. 9A, FIG. 9B, and FIG. 9C, the system determines how to create the new frame 908 based on the amount of excess memory space occupied by original array 906. The excess memory space occupied by original array 906 is memory space that was allocated for (a) extraneous data delivered by incoming frame 902, (b) other data that is extraneous (e.g., padding, a payload of another frame that is a duplicate frame, a payload of another frame that is partially overlapped, etc.), and/or other (c) data that is relevant (e.g., another frame of the same stream that is partially relevant or fully relevant, another frame of a different stream that is partially relevant or fully relevant, etc.). In this example, the system may calculate a ratio between the amount of relevant data delivered by the incoming frame 902 (i.e., the relevant part of the incoming frame's 902 payload) and the capacity of original array 906, and the system may compare the calculated ratio to a threshold ratio. The relevant part of the incoming frame's 902 payload is a portion of the payload, or the relevant part of the incoming frame's 902 payload is all of the payload. Additionally, or alternatively, the system of this example may calculate another ratio between the amount of relevant data delivered by the incoming frame 902 and the total amount of data delivered by the incoming frame 902, and the system may compare this other calculated ratio to another threshold ratio. If these comparison(s) indicate that the amount of excess memory space occupied by original array 906 is relatively low, the system concludes that the incoming frame 902 should be sliced. If the system concludes that the incoming frame 902 should be sliced (YES at Operation 903), the system proceeds to Operation 905. Alternatively, if these comparison(s) indicate that the amount of excess memory space occupied by original array 906 is relatively high, the system concludes that the incoming frame 902 should be partitioned. If the system concludes that the incoming frame 902 should be partitioned (NO at Operation 903), the system proceeds to Operation 907.

In an example embodiment, the system creates the new frame 908 by slicing the incoming frame 902 (Operation 905). More specifically, the system executes a slice method that is offered by original buffer 904 while the system is creating new frame 908. The new buffer 910 represents the relevant data included in the incoming frame's 902 payload. The new buffer 910 is created as a shared subsequence of the original buffer 904. In this scenario, new buffer 910 and original buffer 904 are both backed by original array 906. The original array 906 continues to occupy memory space that was originally allocated for (a) the relevant part of the incoming frame's 902 payload, (b) extraneous part of the incoming frame's 902 payload, and/or (c) any other data that was stored to original array 906 (extraneous or otherwise). Creating the new buffer 910 as a shared subsequence of the original buffer 904 saves the computational cost that would otherwise be incurred by copying the relevant data included in the incoming frame's 902 payload to a different section of memory. However, the fact that the new buffer 910 is backed by the original array 906 means that the excess memory space occupied by original array 906 cannot be reclaimed until after the system has finished processing the new frame 908 and/or new buffer 910. After generating the new frame 908 to replace the incoming frame 902, the system breaks strong reference(s) leading to the incoming frame 902 and/or the original buffer 904. As a result, incoming frame 902 and original buffer 904 are rendered less than strongly reachable. In this scenario, original array 906, new frame 908, and new buffer 910 will remain strongly reachable until after new frame 908 and new buffer 910 are fully processed by the system. This scenario is described in further detail below with reference to FIG. 9B. In an alternative example, if no part of original frame's 902 payload is extraneous, the system may remap original frame 902 to new buffer 910 rather than creating new frame 908.

In an example embodiment, the system partitions incoming frame 902 to create new frame 908 (Operation 907). More specifically, the system executes an allocate method that is offered by original buffer 904 while the system is creating new frame 908. Executing the allocate method results in the creation of a new buffer 910 that is backed by a newly allocated array (hereafter “new array”) 912. In creating the new array 912, the system copies the relevant part of the incoming frame's 902 payload from original array 906, and the system writes the relevant part of the incoming frame's 902 payload to new array 912. In this scenario, the new buffer 910 is not a shared subsequence of the original buffer 904. These two buffers are backed by separate data structures that are stored in separate sections of memory. After generating new frame 908 to replace incoming frame 902, the system breaks strong reference(s) leading to incoming frame 902, original buffer 904, and/or original array 906. As a result, incoming frame 902, original buffer 904, and original array 906 become less than strongly reachable. This scenario is described in further detail below with reference to FIG. 9C. In an alternative example, if no part of original frame's 902 payload is extraneous, the system may remap original frame 902 to new buffer 910 rather than creating new frame 908.

### 6.3 Example Frame Slice

FIG. 9B illustrates an example frame slice that may occur in a managed memory area 900 in accordance with an example embodiment. Managed memory area 900 serves as runtime memory for a program instance that is configured to parse stream data. Stream data is manifested in managed memory area 900 as runtime objects. The program instance processes the stream data by manipulating those runtime objects. While the program instance is currently executing, managed memory area 900 is being subjected to a garbage collection process. The garbage collection process is configured to reclaim a section of memory that describes a runtime object if that runtime object is no longer strongly reachable. References to runtime objects are represented as arrows (e.g., →) in FIG. 9B. As illustrated in FIG. 9B, managed memory area 900 includes incoming frame 902, original buffer 904, original array 906, new frame 908, and new buffer 910.

In an example embodiment, incoming frame 902 is manifested in managed memory area 900 as a runtime object that is related to an incoming frames reference type. In particular, incoming frame 902 is an instance of a subclass that corresponds to frame type of incoming frame 902. For instance, incoming frame 902 may be an instance of a QUIC stream frame class or a QUIC crypto frame class. In the example illustrated by FIG. 9B, there is no chain of strong reference(s) that leads to incoming frame 902. Any strong references to incoming frame 902 were broken after the system created new frame 908. Accordingly, incoming frame 902 is not strongly reachable, and the memory space describing incoming frame 902 may be reclaimed by a garbage collection process.

In an example embodiment, the payload of incoming frame 902 is represented in managed memory area 900 by original buffer 904. Original buffer 904 is a runtime object that is related to a buffer reference type. In particular, original buffer 904 is an instance of a subclass that corresponds to the type of data that is delivered in the incoming frame's 902 payload. For instance, if the incoming frame's 902 payload is binary data, original buffer 904 may be an instance of a byte buffer class. Original buffer 904 is backed by original array 906. In the example illustrated by FIG. 9B, original buffer 904 is referred to strongly by incoming frame 902; however, incoming frame is not strongly reachable, and there is no other chain of strong reference(s) leading to original buffer 904. In other words, original buffer 904 is not strongly reachable and therefore disposable. Accordingly, memory space describing original buffer 904 may be reclaimed by the garbage collection process.

In an example embodiment, original array 906 is a runtime object that is related to an array reference type. In particular, original array 906 is an instance of a subclass that corresponds to the type of data that is delivered in the incoming frame's 902 payload. For instance, if the incoming frame's 902 payload is binary data, original array 906 may be an instance of a byte array class. Original array 906 stores the incoming frame's 902 payload. Original array 906 occupies memory space that is sufficient for storing both (a) the relevant data and (b) extraneous data. However, in the example illustrated by FIG. 9B, the amount of excess memory space occupied by original array 906 (depicted by unshaded rectangles) is relatively low compared to the amount of relevant data stored in original array 906 (depicted by shared rectangles). Original array 906 backs both (a) original buffer 904 and (b) new buffer 910. Original array 906 is referred to strongly by original buffer 904, but, as mentioned previously, original buffer 904 is not strongly reachable. However, in the example illustrated by FIG. 9B, original array 906 is also referred to strongly by new buffer 910. As discussed below, new buffer 910 is strongly reachable. Therefore, original array 906 is strongly reachable through new buffer 910. The memory space occupied by original array 906 is not eligible for reclamation in the example illustrated by FIG. 9B. Consequently, the system may be prevented from reclaiming any of the excess memory space occupied by original array 906 until after the system has fully processed new frame 908 and new buffer 910. The memory space occupied by original array 906 may be much larger than the memory space that is occupied by incoming frame 902 and original buffer 904.

In an example embodiment, new frame 908 is manifested in managed memory area 900 as a runtime object that is related to an incoming frames reference type. In particular, new frame 908 is an instance of a subclass that corresponds to the frame type of new frame 908. New frame 908 is created as a result of incoming frame 902 being sliced by the system. In the example illustrated by FIG. 9B, the system chose to create new frame 908 by slicing incoming frame 902 based, at least in part, on determining that the amount of excess memory space occupied by original array 906 is relatively low. In this example, there is a chain of strong reference(s) that can be traversed by the program instance to access new frame 908. Accordingly, new frame 908 is strongly reachable. New frame 908 will remain strongly reachable until after the system finishes processing new frame 908.

In an example embodiment, the payload of new frame 908 is represented in managed memory area 900 by new buffer 910. The payload of new frame 908 is identical to the payload of original frame 902, or the payload of new frame 908 is a portion of the payload of original frame 902. New buffer 910 is a runtime object that is related to a buffer reference type. In particular, new buffer 910 is an instance of a subclass that corresponds to the type of data that is delivered in the incoming frame's 902 payload. New buffer 910 was created as a result of the system executing a slice method that is offered by original buffer 904. The system executed the slice method offered by original buffer 904 while the system was generating new frame 908. In the example illustrated by FIG. 9B, new buffer 910 is referred to strongly by new frame 908, and new frame 908 is strongly reachable. Therefore, new buffer 910 is also strongly reachable. As noted above, new buffer 910 strongly refers to original array 906, thereby rendering original array 906 strongly reachable.

### 6.4 Example Frame Partition

FIG. 9C illustrates an example frame partition that may occur in a managed memory area 900 in accordance with an example embodiment. Managed memory area 900 serves as runtime memory for a program instance that is configured to parse stream data. Stream data is manifested in managed memory area 900 as runtime objects. The program instance processes the stream data by manipulating those runtime objects. While the program instance is currently executing, managed memory area 900 is being subjected to a garbage collection process. The garbage collection process is configured to reclaim a section of memory that describes a runtime object if that runtime object is no longer strongly reachable. References to runtime objects are represented as arrows (e.g., →) in FIG. 9C. As illustrated in FIG. 9C, managed memory area 900 includes incoming frame 902, original buffer 904, original array 906, new frame 908, new buffer 910, and new array 912.

In an example embodiment, an incoming frame 902 is manifested in managed memory area 900 as a runtime object that is related to an incoming frames reference type. In particular, incoming frame 902 is an instance of a subclass that corresponds to the frame type of incoming frame 902. In the example illustrated by FIG. 9C, there is no chain of strong reference(s) that leads to incoming frame 902. Accordingly, incoming frame 902 is not strongly reachable, and the memory space describing incoming frame 902 may be reclaimed by a garbage collection process.

In an example embodiment, the payload of incoming frame 902 is represented in managed memory area 900 by original buffer 904. Original buffer 904 is a runtime object that is related to a buffer reference type. In particular, original buffer 904 is an instance of a subclass that corresponds to the type of data that is delivered in the incoming frame's 902 payload. Original buffer 904 is backed by original array 906. In the example illustrated by FIG. 9C, original buffer 904 is referred to strongly by incoming frame 902; however, incoming frame 902 is not strongly reachable, and there is no other chain of strong reference(s) leading to original buffer 904. Therefore, original buffer 904 is not strongly reachable. Accordingly, memory space describing original buffer 904 may be reclaimed by the garbage collection process.

In an example embodiment, stream data that is delivered to the system within the payload of incoming frame 902 is stored to original array 906. Original array 906 is a runtime object that is related to an array reference type. In particular, original array 906 is an instance of a subclass that corresponds to the type of data that is delivered in the incoming frame's 902 payload. Original array 906 occupies memory space that is sufficient for storing both (a) relevant data delivered by incoming frame 902 and (b) the extraneous data (e.g., extraneous data delivered by or with incoming frame 902). In the example illustrated by FIG. 9C, the amount of excess memory space occupied by original array 906 may be deemed non-trivial by the system. However, original array 906 does not back new buffer 910 in this example. Original array 906 is referred to strongly by original buffer 904, but, as previously mentioned, original buffer 904 is not strongly reachable. Furthermore, there is no other chain of strong reference(s) leading to original array 906 in this example. Therefore, original array 906 is not strongly reachable, and the memory space occupied by original array 906 is eligible for reclamation by the garbage collection process in the example illustrated by FIG. 9C.

In an example embodiment, new frame 908 is manifested in managed memory area 900 as a runtime object that is related to an incoming frames reference type. In particular, new frame 908 is an instance of a subclass that corresponds to the frame type of new frame 908. New frame 908 is created as a result of incoming frame 902 being partitioned by the system. In the example illustrated by FIG. 9C, the system decided to create new frame 908 by partitioning incoming frame 902 based, at least in part, on determining that the amount of excess memory space occupied by original array 906 is relatively high. In this example, there is a chain of strong reference(s) that can be traversed by the program instance to access new frame 908. Accordingly, new frame 908 is strongly reachable and will remain so until after new frame 908 is fully processed.

In an example embodiment, the payload of new frame 908 is represented in managed memory area 900 by new buffer 910. New buffer 910 is a runtime object that is related to a buffer reference type. In particular, new buffer 910 is an instance of a subclass that corresponds to the type of data that is delivered in the incoming frame's 902 payload. New buffer 910 was created as a result of the system executing an allocate method that is offered by original buffer 904. The system executed the allocate method offered by original buffer 904 while the system was generating new frame 908. In the example illustrated by FIG. 9C, new buffer 910 is referred to strongly by new frame 908, and new frame 908 is strongly reachable. Therefore, new buffer 910 is also strongly reachable and will remain so until the system finishes processing the new frame's 908 payload.

In an example embodiment, new array 912 is a runtime object that is related to an array reference type. In particular, new array 912 is an instance of a subclass that corresponds to the type of data included in the new frame's 908 payload. New array 912 stores the new frame's payload. The payload of new frame 908 is the relevant data that was delivered to the system in the payload of incoming frame 902. The payload of new frame 908 is identical to the payload of original frame 902, or the payload of new frame 908 is a portion of the payload of original frame 902. New array 912 occupies less memory space than original array 906 because the new array 912 is not allocated memory space for the extraneous data that was stored to original array 906. New array 912 is referred to strongly by new buffer 910. As noted above, new buffer 910 is strongly reachable. Therefore, new array 912 is also strongly reachable and will remain so until the relevant data stored to new array 912 is fully processed.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

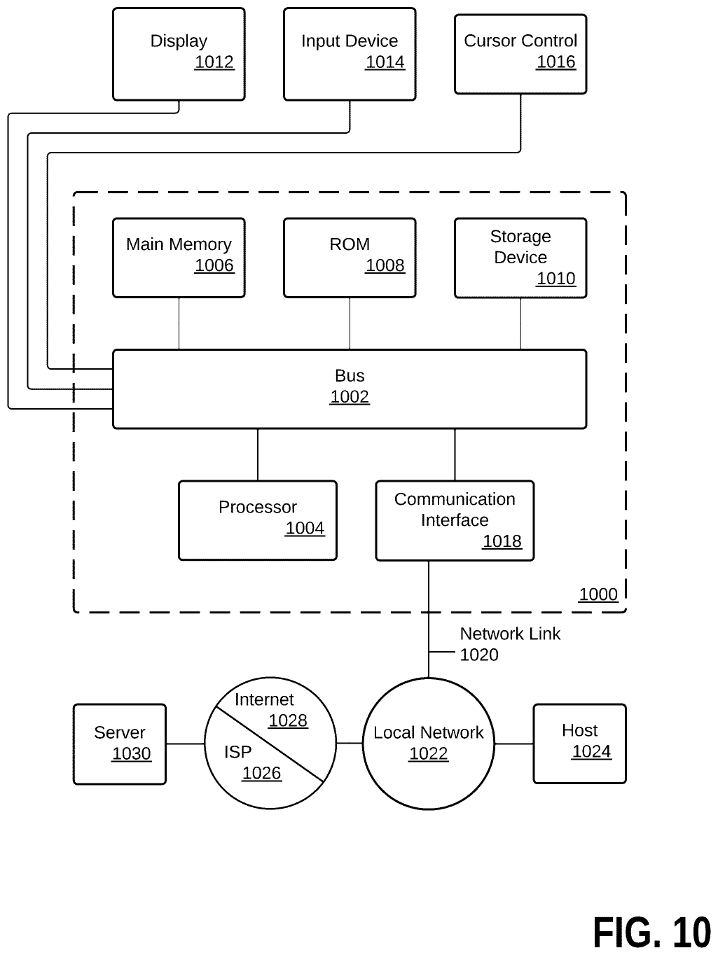

For example, FIG. 10 is a block diagram that illustrates a computer system 1000 upon which an embodiment of the disclosure may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
receiving a first frame of a first set of frames associated with a first protocol, wherein the first set of frames embeds a second set of frames associated with a second protocol;
generating a first runtime object to represent at least part of the first frame in a first section of memory;
determining one or more of:
(a) that a first portion of the first frame is not needed to derive the second set of frames from the first set of frames; or
(b) that the first portion of the first frame is comprised within a second frame of the first set of frames;
(c) the first section of memory comprises a dataset that (a) is not needed to derive the second set of frames from the first set of frames and (b) is not comprised within the first frame;
responsive to determining one or more of (a) that the first portion of the first frame is not needed to derive the second set of frames, (b) that the first portion of the first frame is comprised within the second frame, and/or (c) that the first section of memory comprises the dataset: evaluating a size of a particular portion of the first frame relative to a threshold, wherein the particular portion of the first frame comprises at least one of (a) the first portion of the first frame or (b) a second portion of the first frame; and
based, at least in part, on evaluating the size of the particular portion of the first frame relative to the threshold, performing one of:
(a) generating a second runtime object to represent the particular portion of the first frame in a second section of memory, wherein the particular portion of the first frame is copied from the first section of memory to the second section of memory
(b) generating the second runtime object to represent the particular portion of the first frame in the second section of memory, wherein (a) the particular portion of the first frame is copied from the first section of memory to the second section of memory and (b) the particular portion of the first frame comprises the first portion of the first frame and the second portion of the first frame; or
(c) generating a third runtime object to represent the second portion of the first frame in the first section of memory,
wherein the method is performed by at least one device including a hardware processor.

2. The method of claim 1, wherein the threshold is a threshold size, wherein the particular portion of the first frame is the first portion of the first frame, and wherein evaluating the size of the particular portion of the first frame relative to the threshold comprises:
comparing a first size of the first portion of the first frame to the threshold size, wherein the second runtime object is generated to represent the second portion of the first frame in the second section of memory if the first size of the first portion of the first frame is equal to or greater than the threshold size.

3. The method of claim 2, further comprising:
performing at least one of:
responsive to detecting an increase in an amount of memory available for storing the first set of frames: increasing the threshold size; or
responsive to detecting a decrease in the amount of memory available for storing the first set of frames: decreasing the threshold size.

4. The method of claim 1, wherein the threshold is a threshold ratio, and wherein evaluating the size of the particular portion of the first frame relative to the threshold comprises:
determining a ratio between the size of the particular portion of the first frame and a threshold size, the threshold size comprising at least one of: (a) a first size of the first portion of the first frame or (b) a second size of the second portion of the first frame; and
comparing the ratio to the threshold ratio.

5. The method of claim 1, wherein the threshold is a threshold ratio, and wherein evaluating the size of the particular portion of the first frame relative to the threshold comprises:
determining a ratio between the size of the particular portion of the first frame and a threshold size, the threshold size corresponding to a capacity of the first section of memory; and
comparing the ratio to the threshold ratio.

6. The method of claim 1, wherein the second runtime object is generated responsive to the size of the particular portion of the first frame satisfying the threshold, wherein the second runtime object does not represent the first portion of the first frame, wherein the second section of memory is smaller than the first section of memory, and further comprising:
subsequent to generating the second runtime object to represent the second portion of the first frame in the second section of memory:
reclaiming the first section of memory, wherein the first section of memory comprises (a) the first portion of the first frame and (b) the second portion of the first frame.

7. The method of claim 1:
wherein the third runtime object is generated responsive to determining that the size of the particular portion of the first frame fails to satisfy the threshold;
wherein the third runtime object does not represent the first portion of the first frame; and
wherein the first section of memory comprises (a) the first portion of the first frame and (b) the second portion of the first frame.

8. The method of claim 1, wherein determining that the first portion of the first frame is not needed to derive the second set of frames and/or is comprised within the second frame comprises performing at least one:
comparing a first frame offset of the first frame to an expected offset of a stream, wherein the stream comprises the first set of frames;
comparing the first frame offset to a second frame offset of the second frame;
comparing the first frame offset to a second endpoint of the second frame, wherein the second endpoint of the second frame is determined based on at least one of: (a) the second frame offset of the second frame or (b) a second frame length of the second frame; or
comparing a first endpoint of the first frame to the second frame offset of the second frame, wherein the first endpoint of the first frame is determined based on at least one of: (a) the first frame offset of the first frame or (b) a first frame length of the first frame.

9. The method of claim 1, wherein the first protocol is a lower-layer protocol, wherein the second protocol is a higher-layer protocol, wherein the second portion of the first frame comprises at least part of a higher-layer frame of the second set of frames, and further comprising:
extracting the at least part of the higher-layer frame from the second portion of the first frame;
delivering the at least part of the higher-layer frame to a stream recipient;
discarding the second runtime object or the third runtime object; and
responsive to discarding the second runtime object or the third runtime object, performing at least one of:
(a) reclaiming the first section of memory; or
(b) reclaiming the second section of memory.

10. The method of claim 1, wherein the first frame comprises a first payload, wherein the first portion of the first frame is a first part of the first payload, wherein the second portion of the first frame is a second part of the first payload, and further comprising:
responsive to receiving the first frame: generating a fourth runtime object to represent the first frame;
responsive to determining that the first portion of the first frame is not needed to derive the second set of frames and/or is comprised within the second frame: generating a fifth runtime object to represent a new frame associated with a new payload comprising the second part of the first payload, wherein the new payload is represented by the second runtime object or the third runtime object.
subsequent to generating the fifth runtime object: discarding the fourth runtime object and/or the first runtime object.

11. The method of claim 1, wherein generating the second runtime object or the third runtime object is further based on at least one of: (a) an amount of memory available for storing frames, (b) a differential between a first frame offset of the first frame and an expected offset of a stream comprising the first set of frames, (c) an estimated amount of time that will elapse prior to reclaiming the first section of memory, (d) a liveness ratio of a region comprising the first section of memory, or (e) an indication of malicious activity.

12. The method of claim 1, wherein the dataset comprises at least one of: (a) padding or (b) at least part of a third frame of the first set of frames.

13. One or more non-transitory computer-readable media comprising instructions that, when executed by one or more hardware processors, cause performance of operations comprising:
receiving a first frame of a first set of frames associated with a first protocol, wherein the first set of frames embeds a second set of frames associated with a second protocol;
generating a first runtime object to represent at least part of the first frame in a first section of memory;
determining one or more of:
(a) that a first portion of the first frame is not needed to derive the second set of frames from the first set of frames; or
(b) that the first portion of the first frame is comprised within a second frame of the first set of frames;
(c) the first section of memory comprises a dataset that (a) is not needed to derive the second set of frames from the first set of frames and (b) is not comprised within the first frame;
responsive to determining one or more of (a) that the first portion of the first frame is not needed to derive the second set of frames, (b) that the first portion of the first frame is comprised within the second frame, and/or (c) that the first section of memory comprises the dataset:
evaluating a size of a particular portion of the first frame relative to a threshold, wherein the particular portion of the first frame comprises at least one of (a) the first portion of the first frame or (b) a second portion of the first frame; and
based, at least in part, on evaluating the size of the particular portion of the first frame relative to the threshold, performing one of:
(a) generating a second runtime object to represent the particular portion of the first frame in a second section of memory, wherein the particular portion of the first frame is copied from the first section of memory to the second section of memory
(b) generating the second runtime object to represent the particular portion of the first frame in the second section of memory, wherein (a) the particular portion of the first frame is copied from the first section of memory to the second section of memory and (b) the particular portion of the first frame comprises the first portion of the first frame and the second portion of the first frame; or
(c) generating a third runtime object to represent the second portion of the first frame in the first section of memory.

14. The one or more non-transitory computer-readable media of claim 13, wherein the threshold is a threshold size, wherein the particular portion of the first frame is the first portion of the first frame, and wherein evaluating the size of the particular portion of the first frame relative to the threshold comprises:
comparing a first size of the first portion of the first frame to the threshold size, wherein the second runtime object is generated to represent the second portion of the first frame in the second section of memory if the first size of the first portion of the first frame is equal to or greater than the threshold size.

15. The one or more non-transitory computer-readable media of claim 14, wherein the operations further comprise performing at least one of:
responsive to detecting an increase in an amount of memory available for storing the first set of frames: increasing the threshold size; or
responsive to detecting a decrease in the amount of memory available for storing the first set of frames: decreasing the threshold size.

16. The one or more non-transitory computer-readable media of claim 13, wherein the threshold is a threshold ratio, and wherein evaluating the size of the particular portion of the first frame relative to the threshold comprises:
determining a ratio between the size of the particular portion of the first frame and a threshold size, the threshold size comprising at least one of: (a) a first size of the first portion of the first frame or (b) a second size of the second portion of the first frame; and
comparing the ratio to the threshold ratio.

17. The one or more non-transitory computer-readable media of claim 13, wherein the second runtime object is generated responsive to the size of the particular portion of the first frame satisfying the threshold, wherein the second runtime object does not represent the first portion of the first frame, wherein the second section of memory is smaller than the first section of memory, and wherein the operations further comprise:
subsequent to generating the second runtime object to represent the second portion of the first frame in the second section of memory:
reclaiming the first section of memory, wherein the first section of memory comprises (a) the first portion of the first frame and (b) the second portion of the first frame.

18. The one or more non-transitory computer-readable media of claim 13:
wherein the third runtime object is generated responsive to determining that the size of the particular portion of the first frame fails to satisfy the threshold;
wherein the third runtime object does not represent the first portion of the first frame; and
wherein the first section of memory comprises (a) the first portion of the first frame and (b) the second portion of the first frame.

19. The one or more non-transitory computer-readable media of claim 13, wherein determining that the first portion of the first frame is not needed to derive the second set of frames and/or is comprised within the second frame comprises performing at least one:
comparing a first frame offset of the first frame to an expected offset of a stream, wherein the stream comprises the first set of frames;
comparing the first frame offset to a second frame offset of the second frame;
comparing the first frame offset to a second endpoint of the second frame, wherein the second endpoint of the second frame is determined based on at least one of: (a) the second frame offset of the second frame or (b) a second frame length of the second frame; or
comparing a first endpoint of the first frame to the second frame offset of the second frame, wherein the first endpoint of the first frame is determined based on at least one of: (a) the first frame offset of the first frame or (b) a first frame length of the first frame.

20. A system comprising:
at least one device including a hardware processor;
the system being configured to perform operations comprising:
receiving a first frame of a first set of frames associated with a first protocol, wherein the first set of frames embeds a second set of frames associated with a second protocol;
generating a first runtime object to represent at least part of the first frame in a first section of memory;
determining one or more of:
(a) that a first portion of the first frame is not needed to derive the second set of frames from the first set of frames; or
(b) that the first portion of the first frame is comprised within a second frame of the first set of frames;
(c) the first section of memory comprises a dataset that (a) is not needed to derive the second set of frames from the first set of frames and (b) is not comprised within the first frame;
responsive to determining one or more of (a) that the first portion of the first frame is not needed to derive the second set of frames, (b) that the first portion of the first frame is comprised within the second frame, and/or (c) that the first section of memory comprises the dataset: evaluating a size of a particular portion of the first frame relative to a threshold, wherein the particular portion of the first frame comprises at least one of (a) the first portion of the first frame or (b) a second portion of the first frame; and
based, at least in part, on evaluating the size of the particular portion of the first frame relative to the threshold, performing one of:
(a) generating a second runtime object to represent the particular portion of the first frame in a second section of memory, wherein the particular portion of the first frame is copied from the first section of memory to the second section of memory
(b) generating the second runtime object to represent the particular portion of the first frame in the second section of memory, wherein (a) the particular portion of the first frame is copied from the first section of memory to the second section of memory and (b) the particular portion of the first frame comprises the first portion of the first frame and the second portion of the first frame; or
(c) generating a third runtime object to represent the second portion of the first frame in the first section of memory.
